(19) United States
(12) Patent Application Publication
(10) Pub. No.: US 2012/0101230 A1
(43) Pub. Date: Apr. 26, 2012

(54) HIGH-DENSITY POLYMER SURFACE COATING TO IMMOBILIZE CHEMICAL OR BIOLOGICAL MOLECULES

(76) Inventors: Guobin (Frank) Wang, Woodbridge, CT (US); Lance Laing, Belmont, MA (US)

(21) Appl. No.: 12/366,581

(22) Filed: Feb. 5, 2009

(51) Int. Cl. C08F 8/00

(52) U.S. Cl. 525/54.11; 525/217; 525/328.2

(57) ABSTRACT

A method for providing high-density polymer surface for attaching proteins or peptides, and binding proteins, peptides, DNAs, cells, small molecules, and other chemical or biological molecules that are of interests in the areas of proteomic, genomic, pharmaceutical, drug discovery, and diagnostic studies.

### FIELD OF THE INVENTION

This invention relates to a surface having a high-density polymer coating useful for immobilizing proteins for binding chemical or biological molecules. The invention also relates to methods of generating high-density surface coatings using, for example, carboxyl-containing polymers which are useful, for example, to immobilize proteins with high primary amine density.

### BACKGROUND OF THE INVENTION

With the completion of the sequencing of the human genome, one of the next grand challenges of molecular biology will be to understand how the many protein targets encoded by DNA interact with other proteins, small molecule pharmaceutical candidates, and a large host of enzymes and inhibitors. See e.g., Pandey & Mann, “Proteomics to study genes and genomes,” Nature, 405, p. 837-846, 2000; Leigh Anderson et al., “Proteomics: applications in basic and applied biology,” Current Opinion in Biotechnology, 11, p. 408-412, 2000; Patterson, “Proteomics: the industrialization of protein chemistry,” Current Opinion in Biotechnology, 11, p. 413-418, 2000; MacBeath & Schreiber, “Printing Proteins as Microarrays for High-Throughput Function Determination,” Science, 289, p. 1760-1763, 2000; De Wildt et al., “Antibody arrays for high-throughput screening of antibody-antigen interactions,” Nature Biotechnology, 18, p. 989-994, 2000. To this end, tools that have the ability to simultaneously identify and/or quantify many different biomolecular interactions with high sensitivity will find application in pharmaceutical discovery, proteomics, and diagnostics, and further advance our understanding of the biological world around us. Further, for these tools to find widespread use, they must be simple to use, inexpensive to own and operate, and applicable to a wide range of analytes that can include, for example, polynucleotides, peptides, small proteins, antibodies, and even entire cells.

The immobilization of target molecules onto support surfaces has become an important aspect in the development of biological assays. Generally, biological assays are carried out on the surfaces of microwell plates, microscope slides, tubes, silicone wafers or membranes. The target molecules are covalently immobilized on the surface using coupling reactions between the functional groups on the surface and the functional groups of the molecules. One of popular surface functionalization techniques on glass surface is silanization using functional silanes. Silane, Silicones, and Metal-Organics, p. 88, published by Gelest Inc., Tullytown, Pa. (2000). GAPS II coated slides manufactured by Corning Inc. (Corning, N.Y.), Arryit™ SuperAmine slides supplied by TeleChem International, Inc (Sunnyvale, Calif.), SILANE-PREP™ amine-functionalized slides provided by Sigma Diagnostics (St Louis, Mo.) and others are examples of available biological assay surfaces in microscope slide format. The SuperAmine slide is claimed to provide 5×10¹² amine groups per mm². As another example, amide groups that have been derivatized amidine on a Nylon support are used to immobilize DNA and RNA probes in hybridization assays to detect specific polynucleotide sequences. See U.S. Pat. No. 4,806,546. Products in formats of microwell plates and tubes, including NucleoLink™ and CovaLink™ provided by Nalge Nunc International (Rochester, N.Y.), are available only on polymeric support surfaces. The CovaLink™ products provide a secondary amine surface at approximately 10¹² groups per mm² of surface area. Secondary amines show a lower reactivity than primary amines in many conjugation reactions. See, Loudon, G. Marc, Organic Chemistry, 3d ed., The Benjamin/Cummings Publishing, Redwood City, Calif. (1995).

There are numerous known methods for chemically functionalizing the surfaces of materials, such as silicon, glass or gold for example. Surface functionalization is of great interest, as it often leads to expanded applications for the surface, whereby enhanced binding and analysis of various molecules to the surface becomes possible, relative to a surface with a non-chemically functionalized surface. The type, quantity, and quality of a chemical functionalization coating on a surface determine the covalent strength and capacity of the surface to bind a particular analyte. It is highly desirable that the coating itself not be easily washed away or degraded after multiple uses.

Aldehyde-function groups and amine-functional groups coated on a surface have been shown to provide a versatile platform for detecting biomolecules. These groups can capture biomolecules through physical attraction, such as electrostatic interaction, for example, or chemical binding. Such chemical binding can be achieved directly or indirectly (i.e. through a chemical linker). Many homobifunctional or heterobifunctional linkers are known in the field. A simple method for coating a surface with amine is to directly expose the cleaned surface to polylysine. An example is a glass slide surface used for microarray printing. This type of surface, however, has been shown to be unstable after multiple uses. An alternative to coating a surface with amines is to covalently attach amine-coating molecules to the surface, such as attaching silanes on glass or thiols on gold, both of which are well known.

Various aminoalkylsilane reagents have been used to coat silicon- or glass-based surfaces with amine groups. Processes used in coating such surfaces include the use of a variety of silane reagents, solvents, and different physical treatment procedures. Further, to test the presence of a chemical group on a surface, many methods including radioactive, colorimetric, fluorescence, XPS, FTIR, AFM and others have been used. Sensitivity is an important issue when selecting the appropriate method for surface testing. Generally speaking, there is neither a standard industry procedure to chemically coat a biosensor sensor surface, nor a standardized testing method for detecting the presence or quantity of a particular chemical moiety on such a biosensor.

Aldehyde-functionalized surfaces and amine-functionalized surfaces have been used to immobilize or capture target molecules on the surface of several device formats including microarray, micro-well plate, and well slide. After the target molecule has been immobilized on the surface, it can bind analyte molecules in an unknown sample by specific molecular interaction in order to analyze the sample.

One method of coating a surface with aldehyde binding sites is functionalizing the surface with amine groups and adding an aldehyde solution comprising cyanoborohydride to the amine-functionalized surface. The resulting biosensors can be used for binding proteins and other amine-containing molecules. Some aldehyde-modified slides are also commercially available (e.g., CEL Associates and NoAb BioDiscoveries) for printing arrays.

Biosensors have been developed to detect a variety of biomolecular complexes including oligonucleotides, antibody-antigen interactions, hormone-receptor interactions, and enzyme-substrate interactions. In general, biosensors consist of two components: a highly specific recognition element and a transducer that converts the molecular recognition event into a quantifiable signal. Signal transduction has been accomplished by many methods, including fluorescence, interferometry (Jenison et al., “Interference-based detection of nucleic acid targets on optically coated silicon,” Nature Biotechnology, 19, p. 62-65; Lin et al., “A porous silicon-based optical interferometric biosensor,” Science, 278, p. 840-843, (1997)), and gravimetry (A. Cunningham, Bioanalytical Sensors, John Wiley & Sons (1998)).

Of the optically-based transduction methods, direct methods that do not require labeling of analytes with fluorescent compounds are of interest due to the relative assay simplicity and ability to study the interaction of small molecules and proteins that are not readily labeled. Direct optical methods include surface plasmon resonance (SPR) (Jordan & Corn, “Surface Plasmon Resonance Imaging Measurements of Electrostatic Biopolymer Adsorption onto Chemically Modified Gold Surfaces,” Anal. Chem., 69:1449-1456 (1997)), grating couplers (Morhard et al., “Immobilization of antibodies in micropatterns for cell detection by optical diffraction,” Sensors and Actuators B, 70, p. 232-242, (2000)), ellipsometry (Jin et al., “A biosensor concept based on imaging ellipsometry for visualization of biomolecular interactions,” Analytical Biochemistry, 232, p. 69-72, (1995)), evanescent wave devices (Huber et al., “Direct optical immunosensing (sensitivity and selectivity),” Sensors and Actuators B, 6, p. 122-126, (1992)), and reflectometry (Brecht & Gauglitz, “Optical probes and transducers,” Biosensors and Bioelectronics, 10, p. 923-936, (1995)). Theoretically predicted detection limits of these detection methods have been determined and experimentally confirmed to be feasible down to diagnostically relevant concentration ranges.

Chemical and biological molecules, such as those participating in biological assays, have steric structure in assay mediums. When immobilized on a solid surface, the molecules conformation may be obstructed. When a high density of the chemical or biological molecules is immobilized on a two-dimensional-support surface, steric crowding occurs. Southern, E. et al., Nature Genetics Supp. 21:5 (1999). The issue of steric crowding or accessibility largely influences the interaction of the chemical or biological molecule. This is particularly true for many large-size molecules. For example, Gray and coworkers have reported that oligonucleotide bases appear to dissolve enough from support surfaces to eliminate steric hindrance when ammonia is used to deprotect the oligonucleotide, resulting in an improved hybridization signal being observed. Gray, D E, et al., Langmuir, 13:2833 (1997); Matson, R S, Anal. Biochem. 223(1):110 (1995). Shchepinov et al. have demonstrated that adding spacers between immobilized oligonucleotides and a solid support surface significantly improved hybridization signals. Shchepinov, M. S., et al., Nucleic Acids Res., 25(6):1155-61 (1997).

In order to increase the density of functional groups on a support surface, and to reduce steric hindrance, chemically functional polymers have been used to provide three-dimensional matrixes at the top of the support surface. For example, the three-dimensional protein microarray substrate HydroGel™ coated slides, provided by Perkin Elmer Life Science (Boston, Mass.), provides a highly swellable polymer matrix for protein interaction. This polymeric matrix has a 2 μm thickness when dry and up to 90 μm thickness when fully hydrated. Wang, G. B., et al., Nucleic Acids Res. (in preparation). 3D-Link™ supplied by Amersham Biosciences (Piscataway, N.J.) is also an attempt to provide a three-dimensional polymer microarray substrate. However, the network structure of the crosslinked polymer matrix limits the accessibility of the large-size biomolecules. U.S. Pat. No. 6,413,722, incorporated herein by reference. Reversed-phase surface polymerization can be used to grow non-crosslinked “brush” polymer structure even on most inert polymeric surfaces in aqueous solution through free radical transferring. Wang, G. B., et al., 6^{th} World Biomaterials Congress, Hawaii (2000); U.S. Pat. No. 6,358,557, incorporated herein by reference. The various functionalities and chemical functional group density can be readily obtained by adding functional free radical-polymerizable monomers or mixtures. However, it requires an organic polymer surface or polymeric primer on an inorganic surface. “Brush” polymeric surfaces are also built using free radical polymerization initiated by radical-generating surface on glass silanized with initiator-containing silane. E.P.O. Patent 1,176,423. The synthesis of the silanes is critical for this process. Amine-containing polymers have been covalently attached on amino-silanized glass surface using a coupling agent cyanuric chloride through multi-step reaction. However, cyanuric chloride activation has to be carried out in anhydrous solution, U.S. Pat. No. 6,413,722, and it is limited in process.

Moreover, some proteins, for example proteins that have a high primary amine density, do not immobilize well on aldehyde surfaces. Even though many methods and chemistries have been developed for the attachment of proteins to flat surfaces, they have not been directed to deal specifically with high amine density proteins or for conformal coatings. Furthermore, polymers, such as polymers that can be used to create high density polymer surfaces, are big macromolecules that have large excluded volume in solution. Their size can limit polymer attachment onto the surfaces. Therefore, there remains a need in the art to address these issues.

### SUMMARY OF THE INVENTION

In one embodiment, the invention provides for high-density polymer surfaces comprising polyacrylic acid polymers attached to the surface. The polyacrylic acid polymers can be attached to amine groups on the surface. Further, the polyacrylic acid polymers can have one or more ethanolamine molecules covalently attached.

In another embodiment, the invention provides for methods for creating a high-density polymer surface. The method includes attaching polyacrylic acid polymers to an amine-functionalized surface in the presence of NHS and EDC under conditions where one or more polyacrylic acid polymers react with the amine-functionalized surface. The NHS and EDC can be reacted with the polyacrylic acid polymers prior to their addition to the amine-functionalized surface. The methods can also include the step of attaching one or more ethanolamine molecules to the one or more polyacrylic acid polymers attached to the surface. Furthermore, the methods can also include the step of attaching one or more chemical or biological molecules to the one or more polyacrylic acid polymers attached to the surface. These chemical or biological molecules can be proteins. And these proteins can have a high primary amine density, such as having a pI that is either greater than about 7, or greater than about 9.

A further embodiment of the invention includes methods of immobilizing chemical or biological molecules by contacting the with a high-density polymer surface. These chemical or biological molecules can be proteins. And these proteins can have a high primary amine density, such as having a pI that is either greater than about 7, or greater than about 9.

### BRIEF DESCRIPTION OF THE FIGURES

FIG. 1 is a schematic diagram of various embodiments of an optical grating structure used for a colorimetric resonant reflectance biosensor. n_{substrate} represents substrate material. n₁ represents the refractive index of a cover layer. n₂ represents the refractive index of a one- or two-dimensional grating. n_{bio} represents the refractive index of one or more specific binding substances. t₁ represents the thickness of the cover layer. t₂ represents the thickness of the grating. t_{bio} represents the thickness of the layer of one or more specific binding substances.

FIG. 2 shows a reaction by which a polyacrylic acid polymer is attached to an amine surface.

FIG. 3 shows the coating of polyacrylic acid polymer with different amounts of EDC/NHS, as a function of delta PWV, pm vs. dilution of EDC/NHS (with stock [EDC]=360 mM and stock [NHS]=10 mM).

FIG. 4 shows the COOH groups reacted with ethanolamine as a function of delta PWV, pm vs. dilution of EDC/NHS (with stock [EDC]=360 mM and stock [NHS]=10 mM).

FIG. 5 shows biotin and protein immobilization on PAA with different concentrations of EDC/NHS. 5A shows the results with high COOH density and streptavidin, 5B shows the results with low COOH density and streptavidin, 5C shows the results with high COOH density and avidin, and 5D shows the results with low COOH density and avidin.

FIG. 6 shows the result of the biotin binding to streptavidin on a high COOH density surface of PAA 100K, expressed as PWV versus concentration of streptavidin.

FIG. 7 shows the result of the biotin binding to streptavidin on a low COOH density surface of PAA 100K, expressed as PWV versus concentration of streptavidin.

FIG. 8 shows the result of the biotin binding to streptavidin on a high COOH density surface of PAA 250K, expressed as PWV versus concentration of streptavidin.

FIG. 9 shows the result of the biotin binding to streptavidin on a low COOH density surface of PAA 250K, expressed as PWV versus concentration of streptavidin.

FIG. 10 shows the result of the biotin binding to avidin on a high COOH density surface of PAA 100K, expressed as PWV versus concentration of avidin.

FIG. 11 shows the result of the biotin binding to avidin on a low COOH density surface of PAA 100K, expressed as PWV versus concentration of avidin.

FIG. 12 shows the result of the biotin binding to avidin on a high COOH density surface of PAA 250K, expressed as PWV versus concentration of avidin.

FIG. 13 shows the result of the biotin binding to avidin on a low COOH density surface of PAA 250K, expressed as PWV versus concentration of avidin.

FIG. 14 shows trypsin immobilization.

FIG. 15 shows benzamidine binding to a trypsin-immobilized surface.

FIG. 16 shows trypsin immobilization.

FIG. 17 shows antipain binding to a trypsin-immobilized surface.

FIG. 18 shows leupeptin binding to a trypsin-immobilized surface.

### DETAILED DESCRIPTION OF THE INVENTION

Polymer surfaces, including high-density polymer surfaces, are useful for binding chemical or biological molecules such as proteins, peptides, polypeptides, nucleotides, polynucleotides, small molecules, biotin, cells, fractionated cells, cells extracts, cell fractions, parts of cells and other chemical or biological molecules that are of interest in the areas of, for example, proteomics, genomics, pharmaceuticals, drug discovery, and diagnostic studies. For example, biosensors can have a polymer surface that can bind proteins that are of interest. The invention is directed to high-density polymer surfaces and processes for providing the high density of polymer groups on the surface. The invention can provide a high density of polymers using chemical reagents that do not alter or degrade plastic surfaces, such as those used with a plastic biosensor structure.

The methods of this invention provide, inter alia, methods of creating a high-density polymer surface by attaching carboxyl-containing polymers to an amine-functionalized surface in the presence of carboxylic-acid activating reagents. For example, the carboxyl-containing polymers can be polyacrylic acid polymers or any other carboxyl-containing polymer. In addition, the carboxylic-acid activating reagents can be N-hydroxysulfo-succinimide (“NHS”) and 1-ethyl-3-(3-dimethylaminopropyl)carboiimide (“EDC”), or any other carboxylic-acid activating reagent or reagents.

Other examples of carboxyl-containing polymers that are useful for this invention include, but are not limited to, poly(2-carboxyethyl acrylate), polymethacrylic acid, polymaleic acid, carboxymethyl-dextran, carboxymethyl cellulose, carboxy methyl hydroxyethyl cellulose, 6-carboxymethyl-2′-hydroxyethyl cellulose, poly(p-carboxyphenyl acrylate), poly[N-(5-carboxypentyl)]acrylamide, poly[1-(5-carboxypentylaminocarbonyl)ethylene, poly(4-methacryloyloxybenzoic acid), poly(octyl 2-methylenepropanedioate), and poly(N-{10-[(10-carboxydecyl)carbamoyl]decyl}acrylamide). Other examples of carboxylic-acid activating reagents that are useful for this invention include, but are not limited to, EDC without the use of NHS, N-hydroxysuccinimide, diocyclohexyl carbodiimide, diisopropyl carbodiimide, Woodward's reagent K (N-ethyl-3-phenylisoxazolium-3″-sulfonate), N,N′-carbonyldiimidazole, and aldehydes.

The methods of this invention also include methods of creating a high-density polymer surface by attaching polymers that are not carboxyl-containing polymers. For example, the polymers of this invention can include aldehyde-containing polymers, amine-containing polymers, or hydroxyl containing polymers. For example, imidoesters can be used to create a high-density polymer surface with attached amine-containing polymers. Amine-containing polymers can also be attached to other amine-containing polymers. As another example, DSC can be used to attach hydroxyl-containing polymers. As yet another example, aldehyde-activating reagents can be used create a high-density polymer surface with aldehyde-containing polymers. For example, amine molecules can be used as aldehyde-activating reagents. As one example of this, an amine molecule can be used as an aldehyde-activating reagents, and can subsequently be replaced by another amine molecule either before, during, or after attachment of the aldehyde-containing polymer to the surface.

Polymers, like carboxyl-containing polymers including polyacrylic acid, are big macromolecules with large excluded volume in solution. The size of these polymers limit attachment onto surfaces, such as amine polymer hydrogel surfaces. The Flory-Krigbaum solution theory offers a solution to this problem. According to this theory, which was established in field of physical chemistry of macromolecules, because of changes in the interaction entropy and enthalpy between macromolecules and solvents resulting from changes in solvent or temperature, the excluded volume of a macromolecule can shrink into a coil or cluster, and can even result in precipitation of the macromolecule upon cooling. This temperature is referred to as the theta temperature, and the solvent is referred to as the theta solvent, and the combination of these two is the theta condition. In the case of polymers for the coating of surfaces, there is not much room to adjust the temperature and solvent. However, the polymer structure can be changed temporarily by a reversible process, resulting in the conventional theta condition during the surface coating reaction.

When used in the methods of this invention, the temporary change can be characterized as a reversible precipitation-like or precipitation process. An indication that the polymer structure has undergone the temporary change is that the solution becomes cloudy, or precipitates. One way to characterize this process is phase separation.

As used herein, amine refers to both primary amines having the formula —NH₂ that may be attached directly or through a linking molecule to the surface, as well as secondary amines. An amine-coated surface or an amine-functionalized surface refer to a surface which provides amine groups available for chemical modification, such as the attachment of chemical or biological molecules, either directly or indirectly. Indirect attachment refers to the attachment of chemical or biological molecules through a chemical linker as is well known in the art. Amine-containing polymers that are useful for this invention include, but are not limited to, polyvinylamine and polyethylenimine.

Plastic-based biosensors, or plastic biosensors, refer to those biosensors that contain a plastic grating or sensor surface, a plastic support for the grating, also referred to as a substrate, and/or other plastic components. Such biosensors are susceptible to degradation as the result of reaction conditions used to functionalize the surfaces of the biosensors. Plastics having optical qualities are preferred. The plastic can be clear and transparent without any particulate and can be capable of providing a smooth, flat finish. As an example, a biosensor can include a polyester substrate that supports an acrylic polymer grating layer. Other non-limiting examples of plastics include polyesters and polyurethanes. However, any plastic that provides optical qualities for use in a biosensor may be used. In another example, the grating surface is plastic, such that the plastic serves as both the substrate and the grating.

A high-density polymer surface refers to a surface having a coating through which either other polymers or chemical and biological molecules may be attached. For example, a high-density polymer surface can refer to, but is not limited to, a sensor surface of a plastic-based biosensor having a coating of a high refractive index material. Such high refractive index materials include, for example, silicon nitride, zinc sulfide, titanium dioxide or tantalum oxide. Optionally, a silicon oxide layer can be coated on the high refractive index material prior to surface creation. Either the high refractive index material or the silicon oxide can be used to created a high-density polymer surface for attachment of chemical and biological molecules. The reagents used to create a high-density polymer grating surface coated with the high refractive index material must be compatible with the grating material and the substrate material, whether they are acrylic polymers or other plastic. While the grating is coated with the high refractive index material, which provides some protection of the grating material from the reagents used to create a high-density polymer surface, the opposite side of the grating may still be exposed during the process. Likewise, when the grating is bound to a substrate, the opposite side of the substrate may be exposed to the reagents. Also, imperfections in the coating of the high refractive index material on the grating surface may result in areas of the upper side of the grating surface exposed. Thus, the materials of the various layers and the adhesion between layers should remain intact during creation and any subsequent assay procedures.

A high-density polymer surface of a biosensor refers to plastic-based biosensors, as well as biosensors that are not plastic based. For example, a biosensor includes a titanium oxide-coated sensor, or additional sensors with high refractive index, low index of absorption coating or covering for the top layer and for the base material construction. In addition, silicon dioxide, in all of its various physical forms, or other material with low index of absorption and low refractive index, are contemplated. These biosensors are meant to be exemplary, and are not limiting of biosensors that have an high-density polymer surface.

### Subwavelength Structured Surface (SWS) Biosensor

In one embodiment of the invention, a subwavelength structured surface (SWS) is used to create a sharp optical resonant reflection at a particular wavelength that can be used to track with high sensitivity the interaction of chemical or biological materials, such as specific binding substances or binding partners or both. A colorimetric resonant diffractive grating surface acts as a surface-binding platform for specific binding substances. Like ellipsometry, SPR, and reflectance spectrometry, this method utilizes a change in the refractive index upon a surface to determine when a chemically bound material is present within a specific location.

Subwavelength structured surfaces are an unconventional type of diffractive optic that can mimic the effect of thin-film coatings. (Peng & Morris, “Resonant scattering from two-dimensional gratings,” J. Opt. Soc. Am. A, Vol. 13, No. 5, p. 993, May; Magnusson, & Wang, “New principle for optical filters,” Appl. Phys. Lett., 61, No. 9, p. 1022, August, 1992; Peng & Morris, “Experimental demonstration of resonant anomalies in diffraction from two-dimensional gratings,” Optics Letters, Vol. 21, No. 8, p. 549, April, 1996). A SWS structure contains a surface-relief, one-dimensional or two-dimensional grating in which the grating period is small compared to the wavelength of incident light so that no diffractive orders other than the reflected and transmitted zeroth orders are allowed to propagate. See U.S. patent application Ser. Nos. 10/059,060 and 10/058,626, incorporated by reference in their entirety. A SWS surface narrowband filter can comprise a one-dimensional or two-dimensional grating sandwiched between a substrate layer and a cover layer that fills the grating grooves. Optionally, a cover layer is not used. When the effective index of refraction of the grating region is greater than the substrate or the cover layer, a guided mode resonant effect occurs. When a filter is designed properly, the one-dimensional or two-dimensional grating structure selectively couples light at a narrow band of wavelengths. The light undergoes scattering, and couples with the forward- and backward-propagating zeroth-order light. The guided mode resonant effect occurs over a highly localized region of approximately 3 microns from the point that any photon enters the structure. Because propagation of guided modes in the lateral direction are not supported, a waveguide is not created.

The reflected or transmitted color of this structure can be modulated by the addition of molecules such as specific binding substances or binding partners or both to the upper surface of the cover layer or the one-dimensional or two-dimensional grating surface. The added molecules increase the optical path length of incident radiation through the structure, and thus modify the wavelength at which maximum reflectance or transmittance will occur.

In one embodiment, a biosensor, when illuminated with white light, is designed to reflect only a single wavelength. When specific binding substances, such as chemical and biological molecules, are attached to the surface of the biosensor, the reflected wavelength (color) is shifted due to the change of the optical path of light that is coupled into the grating. By linking specific binding substances to a biosensor surface, complementary binding partner molecules can be detected without the use of any kind of fluorescent probe or particle label. The detection technique is capable of resolving changes of, for example, ˜0.1 nm thickness of protein binding, and can be performed with the biosensor surface either immersed in fluid or dried.

A detection system consists of, for example, a light source that illuminates a small spot of a biosensor at normal incidence through, for example, a fiber optic probe, and a spectrometer that collects the reflected light through, for example, a second fiber optic probe also at normal incidence. Because no physical contact occurs between the excitation/detection system and the biosensor surface, no special coupling prisms are required and the biosensor can be easily adapted to any commonly used assay platform including, for example, microtiter plates and microarray slides. A single spectrometer reading can be performed in several milliseconds, thus it is possible to quickly measure a large number of molecular interactions taking place in parallel upon a biosensor surface, and to monitor reaction kinetics in real time.

This technology is useful in applications where large numbers of biomolecular interactions are measured in parallel, particularly when molecular labels would alter or inhibit the functionality of the molecules under study. High-throughput screening of pharmaceutical compound libraries with protein targets, and microarray screening of protein-protein interactions for proteomics are examples of applications that require the sensitivity and throughput afforded by the compositions and methods of the invention.

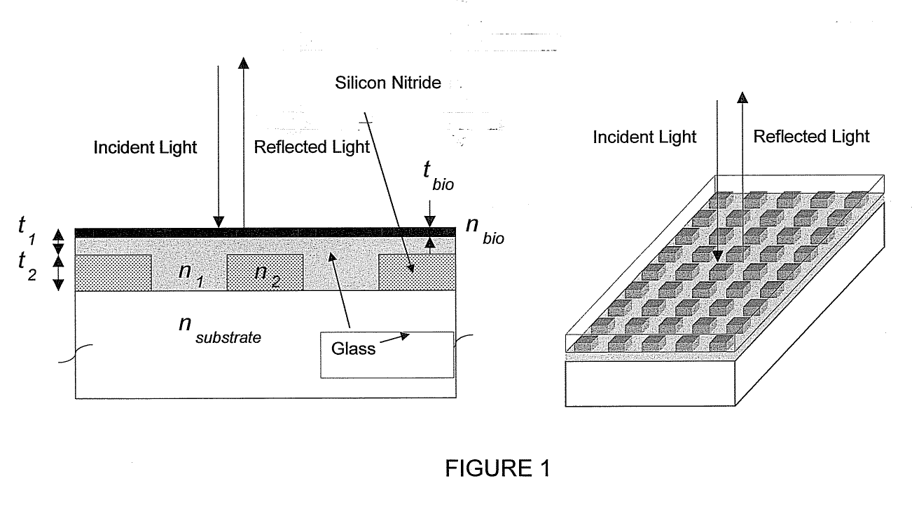

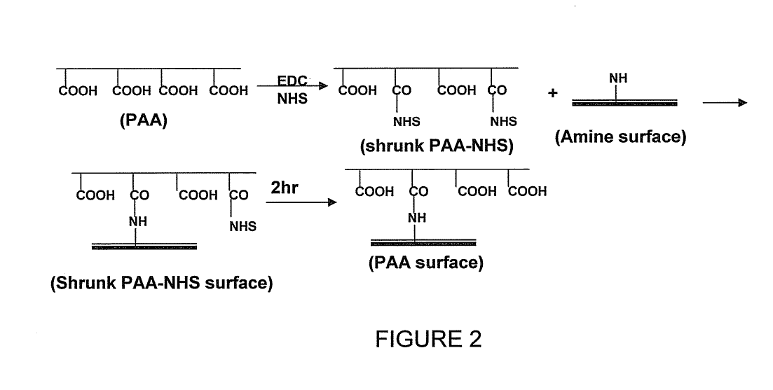

A schematic diagram of an example of a SWS structure is shown in FIG. 1. In FIG. 1, n_{substrate} represents a substrate material. n₁ represents the refractive index of an optional cover layer. n₂ represents the refractive index of a two-dimensional grating. N_{bio} represents the refractive index of one or more specific binding substances. t₁ represents the thickness of the cover layer above the two-dimensional grating structure. t₂ represents the thickness of the grating. t_{bio} represents the thickness of the layer of one or more specific binding substances. In one embodiment, n₂>n₁. (see FIG. 1). Layer thicknesses (i.e. cover layer, one or more specific binding substances, or a grating) are selected to achieve resonant wavelength sensitivity to additional molecules on the top surface. The grating period is selected to achieve resonance at a desired wavelength. The structures can be fabricated from glass and silicon nitride dielectric materials. Alternatively, structures may be formed from embossed plastic with an appropriate dielectric cover layer.

One embodiment of the invention provides a SWS biosensor. A SWS biosensor comprises a one-dimensional or two-dimensional grating, a substrate layer that supports the grating, and one or more specific binding substances immobilized on the surface of the grating opposite of the substrate layer.

A one-dimensional or two-dimensional grating can be comprised of a material, including, for example, zinc sulfide, titanium dioxide, tantalum oxide, and silicon nitride. A cross-sectional profile of the grating can comprise any periodically repeating function, for example, a “square-wave.” A grating can be comprised of a repeating pattern of shapes selected from the group consisting of continuous parallel lines squares, circles, ellipses, triangles, trapezoids, sinusoidal waves, ovals, rectangles, and hexagons. A sinusoidal cross-sectional profile is preferable for manufacturing applications that require embossing of a grating shape into a soft material such as plastic, or replicating a grating surface into a material such as epoxy. In one embodiment of the invention, the depth of the grating is about 0.01 micron to about 1 micron and the period of the grating is about 0.01 micron to about 1 micron.

A SWS biosensor can also comprise a one-dimensional linear grating surface structure, i.e., a series of parallel lines or grooves. A one-dimensional linear grating is sufficient for producing the guided mode resonant filter effect. While a two-dimensional grating has features in two lateral directions across the plane of the sensor surface that are both subwavelength, the cross-section of a one-dimensional grating is only subwavelength in one lateral direction, while the long dimension can be greater than wavelength of the resonant grating effect. A one-dimensional grating biosensor can comprise a high refractive index material that is coated as a thin film over a layer of lower refractive index material with the surface structure of a one-dimensional grating. Alternatively, a one dimensional grating biosensor can comprise a low refractive index material substrate, upon which a high refractive index thin film material has been patterned into the surface structure of a one-dimensional grating. The low refractive index material can be glass, plastic, polymer, or cured epoxy. The high refractive index material must have a refractive index that is greater than the low refractive index material. The high refractive index material can be zinc sulfide silicon nitride, tantalum oxide, titanium dioxide, or indium tin oxide, for example.

In one embodiment, a SWS structure is used as a microarray platform by, for example, building a grating surface that is the same size as a standard microscope slide and placing microdroplets of high affinity chemical receptor reagents onto an x-y grid of locations on the grating surface. Alternatively, the SWS structure is built to be the same size as a standard microtiter plate, and incorporated into the bottom surface of the entire plate. When the chemically functionalized surface, for example the microarray/microtiter plate, is exposed to molecules, such as an analytes, the molecules will be preferentially attracted to locations that have high affinity. As a result, some surface locations gather additional material, and other surface locations do not. The surface locations that attract additional material can be determined by measuring the shift in resonant wavelength within each individual surface location, such as each individual microarry/microtiter surface location. Thus, for example, the amount of bound molecules, such as analytes, in the sample and the chemical affinity between receptor reagents and the molecules can be determined by measuring the extent of the shift of the resonant wavelength.

In one embodiment of the invention, an interaction of a first molecule with a second test molecule can be detected. A SWS biosensor as described above is used; however, there are no specific binding substances immobilized on its surface. Therefore, the biosensor comprises a one- or two-dimensional grating, a substrate layer that supports the one- or two-dimensional grating, and optionally, a cover layer. As described above, when the biosensor is illuminated a resonant grating effect is produced on the reflected radiation spectrum, and the depth and period of the grating are less than the wavelength of the resonant grating effect.

To detect an interaction of a first molecule with a second test molecule, a mixture of the first and second molecules is applied to a distinct location on a biosensor. A distinct location can be one spot or well on a biosensor or can be a large area on a biosensor. A mixture of the first molecule with a third control molecule is also applied to a distinct location on a biosensor. The biosensor can be the same biosensor as described above, or can be a second biosensor. If the biosensor is the same biosensor, a second distinct location can be used for the mixture of the first molecule and the third control molecule. Alternatively, the same distinct biosensor location can be used after the first and second molecules are washed from the biosensor. The third control molecule does not interact with the first molecule and is about the same size as the first molecule. A shift in the reflected wavelength of light from the distinct locations of the biosensor or biosensors is measured. If the shift in the reflected wavelength of light from the distinct location having the first molecule and the second test molecule is greater than the shift in the reflected wavelength from the distinct location having the first molecule and the third control molecule, then the first molecule and the second test molecule interact. Interaction can be, for example, hybridization of nucleic acid molecules, specific binding of an antibody or antibody fragment to an antigen, and binding of polypeptides. A first molecule, second test molecule, or third control molecule can be, for example, a nucleic acid, polypeptide, antigen, polyclonal antibody, monoclonal antibody, single chain antibody (scFv), F(ab) fragment, F(ab)₂ fragment, Fv fragment, small organic molecule, cell, virus, and bacteria.

### Amine-Functionalized Surface

After a layer of high refractive index material, such as silicon nitride, is coated on the structure, such as a plastic structure, the device is prepared by the attachment of amine-functional groups on the surface of the high refractive index material. Attachment of amine-functional groups can either produce an amine-functionalized surface, or can be used for the creation of high-density polymer surface with, for example, carboxyl-containing polymers. Plastic-based biosensors can be degraded (i.e. structure or composition change on the sensor) during the chemical modification that provides amine functional groups on its surface. To avoid such degradation, the present invention provides for a process for amine functionalization of a surface using reagents that are compatible with the plastic of the biosensor. After a high refractive index material has been deposited on the grating surface of the plastic biosensor, the sensor may be stored or may be used directly for functionalization. The sensor may be subjected to a cleaning step using wet (e.g. cleaning using a liquid, such as solvent) or dry (e.g., UV ozone or plasma) methods prior to the amine functionalization procedure. In one embodiment, the amine functionalization procedure includes (a) exposing a plastic colorimetric resonant biosensor to an alcoholic silane solution, and then (b) rinsing the exposed plastic colorimetric resonant biosensor with an alcohol. When the biosensor is dried, the grating surface contains amine functional groups, i.e., —NH₂ groups.

In one aspect of the invention, the silane solution includes a 3-aminopropyltriethoxysilane and an alcohol, such as ethanol or other suitable low molecular weight alcohol. Likewise any suitable low molecular weight alcohol may be used to rinse the biosensor. An example of coating the plastic biosensor with amine is first exposing the sensor to a solution containing 3-aminopropyltriethoxysilane and ethanol, then briefly rinsing the sensor in ethanol, and finally drying the sensor. The concentration of the 3-aminopropylsilane in ethanol may be adjusted such that the concentration of the 3-aminopropylsilane is from about 1% to about 15% in ethanol. In addition, the ethanol may be about 90%-100% (volume/volume, adjusted with water). The drying step may be done in an oven at about, 70° C. for 10 min for example. The drying may be performed at higher temperatures, provided the temperature is selected such that biosensor degradation does not occur.

In accordance with the invention, numerous suitable solvents, concentrations, reaction times, and curing/incubation times may be utilized. Contemplated variations of the invention includes the type of surface, the silane reagent (including silanes such as 3-aminopropyltrimethoxysilane, etc.), the silane concentration, the coating solvent or a combination of solvents (e.g. ethanol and water), the coating reaction time, the rinse solvent or a combination of solvents (e.g. ethanol and water), the curing time, and the curing temperature.

### Surface Treatment

In one embodiment of the invention, the surface can be modified by chemical treatment. For example, the surface can be treated with a solution by immersing the surface in the solution. Alternatively, gas-phase treatment, including chemical vapor or atomization deposition can also be used for a coating of the surface. Gas-phase treatment can be used to ensure a conformal coating of the geometrically non-flat surface. Such a coating can be used in a step of silanizing a surface, or for the addition of other organic materials to a surface. Other methods by which a surface can be treated will be recognized by those skilled in the art.

Treatment by plasma can be commonly used prior to the gas-phase coating processes. The plasma treatment can remove most contamination on the surface and activate some of the surfaces to improve the adhesion of the subsequent gas-phase coating process.

The gas-phase coating process can be used to add chemical functionality and minimize adsorbed moisture, organic contaminants, and low molecular weight material, on the surface of polymer films. The gas-phase coating has advantages including, but not limited to, the uniform treatment of surfaces, no backside treatment when polymer films are treated, no pin-holes when treating porous materials. Such coating services useful in this invention include but are not limited services provided by Sigma Technologies (Tucson, Ariz.), 4th State (Belmont, Calif.), Yield Engineering (San Jose, Calif.), Erie Scientific (Portsmouth, N.H.), and AST Products (advanced surface technologies) (Billerica, Mass.).

### Acoustic Biosensors

In another embodiment of the invention, an acoustic biosensor is used. Acoustic biosensors measures the binding of a molecule, such as an analyte, to a chemical or biological molecule that is covalently attached to the surface by detecting a change in the resonant oscillating frequency on the biosensor surface caused by a change in deposited mass as a result of the binding of the molecule and/or analyte. The resonant oscillating frequency can be measured, for example, by using piezoresistive devices, mechanical vibrators, such as micromachined cantilevers, membranes, or tuning forks, or surface acoustic wave oscillators.

### Electronic Biosensors

In another embodiment of the invention, an electronic biosensor is used. Electronic biosensors measures the binding of a molecule, such as an analyte, to a chemical of biological molecule that is covalently attached to the surface by detecting a change of resistively, for example DC or AC, low or high frequency, capacitance, or inductance on the biosensor surface caused by a change in deposited mass as a result of the binding of the molecule and/or analyte.

Specific Binding Substances and Binding Partners

One or more specific binding substances are immobilized on the high-density polymer surface of the one- or two-dimensional grating or cover layer, if present, by for example, physical adsorption or by chemical binding. A specific binding substance can be, for example, a nucleic acid, peptide, polypeptide, protein, antigen, polyclonal antibody, monoclonal antibody, single chain antibody (scFv), F(ab) fragment, F(ab′)₂ fragment, Fv fragment, small organic molecule, biotin cell, virus, bacteria, polymer, peptide solutions, single- or double-stranded DNA solutions, RNA solutions, solutions containing compounds from a combinatorial chemical library, or biological sample. A biological sample can be for example, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, or prostatic fluid.

Preferably, one or more specific binding substances are arranged in a microarray of distinct locations on a biosensor. A microarray of specific binding substances comprises one or more specific binding substances on a surface of a biosensor of the invention such that a surface contains many distinct locations, each with a different specific binding substance or with a different amount of a specific binding substance. For example, an array can comprise 1, 10, 100, 1,000, 10,000, or 100,000 distinct locations. Such a biosensor surface is called a microarray because one or more specific binding substances are typically laid out in a regular grid pattern in x-y coordinates. However, a microarray of the invention can comprise one or more specific binding substance laid out in any type of regular or irregular pattern. For example, distinct locations can define a microarray of spots of one or more specific binding substances. A microarray spot can be about 50 to about 500 microns in diameter. A microarray spot can also be about 150 to about 200 microns in diameter. One or more specific binding substances can be bound to their specific binding partners.

A microarray on a biosensor of the invention can be created by placing microdroplets of one or more specific binding substances onto, for example, an x-y grid of locations on a one- or two-dimensional grating or cover layer surface. When the biosensor is exposed to a test sample comprising one or more binding partners, the binding partners will be preferentially attracted to distinct locations on the microarray that comprise specific binding substances that have high affinity for the binding partners. Some of the distinct locations will gather binding partners onto their surface, while other locations will not.

A specific binding substance specifically binds to a binding partner that is added to the surface of a biosensor of the invention. A specific binding substance specifically binds to its binding partner, but does not substantially bind other binding partners added to the surface of a biosensor. For example, where the specific binding substance is an antibody and its binding partner is a particular antigen, the antibody specifically binds to the particular antigen, but does not substantially bind other antigens. A binding partner can be, for example, a nucleic acid, polypeptide, antigen, polyclonal antibody, monoclonal antibody, single chain antibody (scFv), F(ab) fragment, F(ab′)₂ fragment, Fv fragment, small organic molecule, cell, virus, bacteria, polymer, peptide solutions, single- or double-stranded DNA solutions, RNA solutions, solutions containing compounds from a combinatorial chemical library and biological sample. A biological sample can be, for example, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, and prostatic fluid.

One example of a microarray of the invention is a nucleic acid microarray, in which each distinct location within the array contains a different nucleic acid molecule. In this embodiment, the spots within the nucleic acid microarray detect complementary chemical binding with an opposing strand of a nucleic acid in a test sample.

While microtiter plates are the most common format used for biochemical assays, microarrays are increasingly seen as a means for maximizing the number of biochemical interactions that can be measured at one time while minimizing the volume of precious reagents. By application of specific binding substances with a microarray spotter onto a biosensor of the invention, specific binding substance densities of 10,000 specific binding substances/in² can be obtained. By focusing an illumination beam to interrogate a single microarray location, a biosensor can be used as a label-free microarray readout system.

### Immobilization of One or More Specific Binding Substances

Immobilization of one or more binding substances onto a biosensor is performed so that a specific binding substance will not be washed away by rinsing procedures, and so that its binding to binding partners in a test sample is unimpeded by the biosensor surface. Several different types of surface chemistry strategies have been implemented for covalent attachment of specific binding substances to, for example, glass for use in various types of microarrays and biosensors. These same methods can be readily adapted to a biosensor of the invention. Surface preparation of a biosensor so that it contains the correct functional groups for binding one or more specific binding substances is an integral part of the biosensor manufacturing process.

As used herein, the terms “target molecule” or “chemical or biological molecules” or “specific binding substances” refer to any specific binding substances that can be attached to the high-density polymer surface. Chemical or biological molecules can be selected from the group consisting of, e.g., proteins, peptides, polypeptides, nucleotides, polynucleotides, small molecules, biotin, cells, fractionated cells, cells extracts, cell fractions, and parts of cells.

As used herein, the terms protein, peptide and polypeptide refer to a polymer of amino acid residues. The terms also apply to amino acid polymers in which one or more amino acids are chemical analogues of corresponding naturally-occurring amino acids, including amino acids which are modified by post-translational processes (e.g., glycosylation and phosphorylation). The term “protein,” as used herein, means any protein, including, but not limited to peptides, enzymes, glycoproteins, hormones, receptors, antigens, antibodies, growth factors, etc., without limitation.

The term “polypeptide” refers to a polymer of amino acids without regard to the length of the polymer; thus, peptides, oligopeptides, and proteins are included within the definition of polypeptide. This term refers to both naturally occurring polypeptides and synthetic polypeptides. This term can include chemical or post-expression modifications of the polypeptide. Therefore, for example, modifications to polypeptides which include the covalent attachment of glycosyl groups, acetyl groups, phosphate groups, lipid groups and the like are expressly encompassed by the term polypeptide. A chemically modified polypeptide includes polypeptides where an identification or capture tag has been incorporated into the polypeptide. The natural or other chemical modifications, such as those listed in example above, can occur anywhere in a polypeptide, including the peptide backbone, the amino acid side-chains and the amino or carboxyl termini. It will be appreciated that the same type of modification may be present in the same or varying degrees at several sites in a given polypeptide. Also, a given polypeptide may contain many types of modifications. Polypeptides may be branched, for example, as a result of ubiquitination, and they may be cyclic, with or without branching. Modifications include acetylation, acylation, ADP-ribosylation, amidation, covalent attachment of flavin, covalent attachment of a heme moiety, covalent attachment of a nucleotide or nucleotide derivative, covalent attachment of a lipid or lipid derivative, covalent attachment of phosphatidylinositol, cross-linking, cyclization, disulfide bond formation, demethylation, formation of covalent cross-links, formation of cysteine, formation of pyroglutamate, formylation, gamma-carboxylation, glycosylation, GPI anchor formation, hydroxylation, hydrogenation, iodination, methylation, myristoylation, oxidation, pegylation, proteolytic processing, phosphorylation, prenylation, racemization, selenylation, sulfation, transfer-RNA mediated addition of amino acids to proteins such as arginylation, and ubiquitination. (See, e.g., Proteins—Structure and Molecular Properties, 2nd Ed., T. E. Creighton, W. H. Freeman and Company, New York (1993); Posttranslational Covalent Modification of Proteins, B. C. Johnson, Ed., Academic Press, New York, pgs. 1-12 (1983); Seifter et al., Meth Enzymol 182:626-646 (1990); Rattan et al., Ann NY Acad Sci 663:48-62 (1992)). Also included within the definition are polypeptides which contain one or more analogs of an amino acid (including, for example, non-naturally occurring amino acids, amino acids that only occur naturally in an unrelated biological system, modified amino acids from mammalian systems etc.), polypeptides with substituted linkages, as well as other modifications known in the art, both naturally occurring and non-naturally occurring. The polypeptide may be naturally occurring or synthetic

As used herein, “small molecule” refers to molecules that are less than around 2,500 Daltons. These molecules include, for example, small organic molecules, such as biotin, but also include small peptides, such as peptidomimetics, as well as nucleotides, such as those commonly found in antiviral screening libraries. Small molecules can refer to both synthetic molecules, which can be diversity oriented and smaller in size, and natural compounds, which tend to have larger molecular weights. Small molecules also include orally acting drugs, which have an upper size range of about 500 Daltons. See Lipinski, C. A. “Drug-like Properties and the Causes of Poor Solubility and Poor Permeability,” J. Pharm. And Tox. Methods. 44:235 (2000) at 236.

One or more specific binding substances can be attached to a biosensor surface by physical adsorption (i.e., without the use of chemical linkers) or by chemical binding (i.e., with the use of chemical linkers). Chemical binding can generate stronger attachment of specific binding substances on a biosensor surface and provide defined orientation and conformation of the surface-bound molecules.

Examples of types of chemical binding on the high-density polymer surface include, for example, amine functionalization, aldehyde functionalization, carboxyl functionalization, and biotin, glutathione-S-transferase (GST), and nickel activation. These surfaces can be used to attach specific binding substances directly to a biosensor surface or through the use of several different types of chemical linkers, as shown in Table 1. See also, Hermanson, Bioconjugate Techniques, Academic Press, NY, 1996.

TABLE 1

| Sensor | | Targeted Groups on |
|---|---|---|
| Surface | | Specific Binding |
| Group | Chemical Linkers | Substances |
| Amine | Sulfosuccinimidyl-6-(biotinamido)hexanoate | Streptavidin or |
| | (sulfo-NHS-LC-biotin) | avidin |
| | N,N′-disuccinimidyl carbonate | Amine |
| | (DSC, non-cleavable linker) | |
| | Dimethyl 3,3′-dithiobispropionimidate | Amine |
| | (DTBP, cleavable linker) | |
| | 1-Ethyl-3-(3-Dimethylaminopropyl)carbodiimide (EDC)/ | Carboxyl |
| | N-Hydroxysulfosuccinimide (NHS) | |
| | Sulfo-succinimidyl 6-[a-methyl-a-(2-pyridyl-dithio) | Sulfhydryl |
| | toluamido]hexanoate (Sulfo-LC-SMPT, cleavable linker), | |
| | Sulfo-succinimidyl 4-(N-maleimidomethyl) cyclohexane- | Sulfhydryl |
| | 1-carboxylate (Sulfo-SMCC, non-cleavable linker) | |
| Aldehyde | | Amine |
| Carboxyl | | Amine |
| Nickel (II) | | His-tagged |
| | | biomolecules |
| Biotin | | Streptavidin |
| | | or avidin |
| Glutathione | | GST-tagged |
| | | biomolecules |

While an amine-functionalized surface can be used to attach several types of linker molecules, an aldehyde-functionalized or carboxy-functionalized surface can be used to bind proteins directly, without an additional linker. For example, an aldehyde-functional coating on a surface is less than about 50 Angstroms thick. Also, the surface can be flat or not flat. A “not flat” surface can be, for example, a surface comprising a grating, as described herein. A “flat” surface can be, for example, a surface comprising a grating with an overcoat, such as silicon oxide or spin-on-glass (SOG), as described, for example, in U.S. patent application Ser. No. 09/930,352, filed Aug., 15, 2001 and U.S. patent application Ser. No. 10/059,060, filed Jan. 29, 2002 (which are incorporated by reference). A nickel surface can be used to bind molecules that have an incorporated histidine (“his”) tag. Detection of “his-tagged” molecules with a nickel-activated surface is well known in the art (Whitesides, Anal. Chem. 68, 490, (1996)).

Immobilization of specific binding substances to the surface of the plastic sensor, which can be an oxide, for example, can be performed essentially as described for immobilization to glass. However, the wash and coating treatment steps that would damage the material to which the specific binding substances are immobilized should be eliminated.

For the detection of binding partners at concentrations less than about ˜0.1 ng/ml, it is preferable to amplify and transduce binding partners bound to a biosensor into an additional layer on the biosensor surface. The increased mass deposited on the biosensor can be easily detected as a consequence of increased optical path length. By incorporating greater mass onto a biosensor surface, the optical density of binding partners on the surface is also increased, thus rendering a greater resonant wavelength shift than would occur without the added mass. The addition of mass can be accomplished, for example, enzymatically, through a “sandwich” assay, or by direct application of mass to the biosensor surface in the form of appropriately conjugated beads or polymers of various size and composition. This principle has been exploited for other types of optical biosensors to demonstrate sensitivity increases over 1500× beyond sensitivity limits achieved without mass amplification. See, e.g., Jenison et al., “Interference-based detection of nucleic acid targets on optically coated silicon,” Nature Biotechnology, 19: 62-65, 2001.

As an example, an amine-functionalized sensor surface can have a specific binding substance comprising a single-strand DNA captured probe immobilized on the surface. The capture probe interacts selectively with its complementary binding partner. The binding partner, in turn, can be designed to include a sequence or tag that will bind a “detector” molecule. A detector molecule can contain, for example, a linker to horseradish peroxidase (HRP) that, when exposed to the correct enzyme, will selectively deposit additional material on the biosensor only where the detector molecule is present. Such a procedure can add, for example, 300 angstroms of detectable biomaterial to the biosensor within a few minutes.

A “sandwich” approach can also be used to enhance detection sensitivity. In this approach, a large molecular weight molecule can be used to amplify the presence of a low molecular weight molecule. For example, a binding partner with a molecular weight of, for example, about 0.1 kDa to about 20 kDa, can be tagged with, for example, succinimidyl-6-[a-methyl-a-(2-pyridyl-dithio) toluamido] hexanoate (SMPT), or dimethylpimelimidate (DMP), histidine, or a biotin molecule. Where the tag is biotin, the biotin molecule will binds strongly with streptavidin, which has a molecular weight of 60 kDa. Because the biotin/streptavidin interaction is highly specific, the streptavidin amplifies the signal that would be produced only by the small binding partner by a factor of 60.

Detection sensitivity can be further enhanced through the use of chemically derivatized small particles. “Nanoparticles” made of colloidal gold, various plastics, or glass with diameters of about 3-300 nm can be coated with molecular species that will enable them to covalently bind selectively to a binding partner. For example, nanoparticles that are covalently coated with streptavidin can be used to enhance the visibility of biotin-tagged binding partners on the biosensor surface. While a streptavidin molecule itself has a molecular weight of 60 kDa, the derivatized bead can have a molecular weight of any size, including, for example, 60 KDa. Binding of a large bead will result in a large change in the optical density upon the biosensor surface, and an easily measurable signal. This method can result in an approximately 1000× enhancement in sensitivity resolution.

Methods of using Biosensors

Biosensors of the invention can be used to study one or a number of specific binding substance/binding partner interactions in parallel. Binding of one or more specific binding substances to their respective binding partners can be detected, without the use of labels, by applying one or more binding partners to the biosensor that have one or more specific binding substances immobilized on their surfaces. For example, an SWS biosensor is illuminated with light and a maxima in reflected wavelength, or a minima in transmitted wavelength of light is detected from the biosensor. If one or more specific binding substances have bound to their respective binding partners, then the reflected wavelength of light is shifted as compared to a situation where one or more specific binding substances have not bound to their respective binding partners. Where a SWS biosensor is coated with an array of distinct locations containing the one or more specific binding substances, then a maxima in reflected wavelength or minima in transmitted wavelength of light is detected from each distinct location of the biosensor.

In one embodiment of the invention, a variety of specific binding substances, for example, high amine density proteins, can be immobilized in an array format onto a biosensor of the invention. The biosensor is then contacted with a test sample of interest comprising binding partners, such as small molecules or other proteins. Only the binding partners that specifically bind to the proteins immobilized on the biosensor remain bound to the biosensor.

The activity of an enzyme can be detected by applying one or more enzymes to a biosensor to which one or more specific binding substances have been immobilized. For example, the biosensor is washed and illuminated with light. The reflected wavelength of light is detected from the biosensor. Where the one or more enzymes have altered the one or more specific binding substances of the biosensor by enzymatic activity, the reflected wavelength of light is shifted.

Additionally, a test sample, for example, cell lysates containing binding partners can be applied to a biosensor of the invention, followed by washing to remove unbound material. The binding partners that bind to a biosensor can be eluted from the biosensor and identified by, for example, mass spectrometry. Optionally, a phage DNA display library can be applied to a biosensor of the invention followed by washing to remove unbound material. Individual phage particles bound to the biosensor can be isolated and the inserts in these phage particles can then be sequenced to determine the identity of the binding partner.

For the above applications, and in particular proteomics applications, the ability to selectively bind material, such as binding partners from a test sample onto a biosensor of the invention, followed by the ability to selectively remove bound material from a distinct location of the biosensor for further analysis is advantageous. Biosensors of the invention are also capable of detecting and quantifying the amount of a binding partner from a sample that is bound to a biosensor array distinct location by measuring the shift in reflected wavelength of light. For example, the wavelength shift at one distinct biosensor location can be compared to positive and negative controls at other distinct biosensor locations to determine the amount of a binding partner that is bound to a biosensor array distinct location.

### Example 1

### Fabrication of a SWS Biosensor

The detailed manufacture process of the SWS biosensor has been described previously. See, e.g., Cunningham B. et al., Sensor and Actuators B 6779, 1-6 (2002), incorporated herein by reference. Specifically, an optical-grade polymer film was used as a support of an SWS sensor. A UV-curable acrylic-based polymer coating was coated onto the film and replicated using a silicon mask that has 96 circles corresponding to the standard format of a 96-well micro-titer plate, which circles form an SWS structure. A UV lamp RC600, provided by Xenon Corporation (Woburn, Mass.), was used to cure the coating after the replication. Subsequently, a thin titanium dioxide layer and a silicone dioxide layer were deposited onto the top of the surface.

### Example 2

### Attachment of Polyacrylic Acid (“PAA”) Polymers to Biosensor Surfaces

A plasma-treated biosensor surface was prepared by adding 0.25% 3-glycidoxypropyltrimethoxysilane in acetone using a Flexdrop precision reagent dispenser (Perkin Elmer), and incubating overnight at room temperature with 60% relative humidity. 5% purified polyvinyl amine (“PVA”) was added to the surfaces and allowed to incubate for 2 hr. Subsequently the surface was washed with DI water. Both 5% PAA (moleculer weight 100K) in water or 5% PAA (moleculer weight 250K) in water was mixed with an either equal volume of 1, 1/50, 1/20, 1/12, 1/8, or 1/6 dilution of 0.34M EDC and 10 mM NHS in water (EDC/NHS). 20 μl of each mixture was added into wells of the prepared surface and incubated for 2 hr, followed by a DI water wash.

The appearance of the PAA solutions after mixing with EDC/NHS but prior to addition to the surface is shown in the following table:

| | EDC/NHS dilution | | | | | |
|---|---|---|---|---|---|---|
| | 0 | 1/50 | 1/20 | 1/12 | 1/8 | 1/6 |
| PAA 250K | clear | clear | clear | clear | cloudy | cloudy |
| PAA 100K | clear | clear | clear | clear | clear | cloudy |

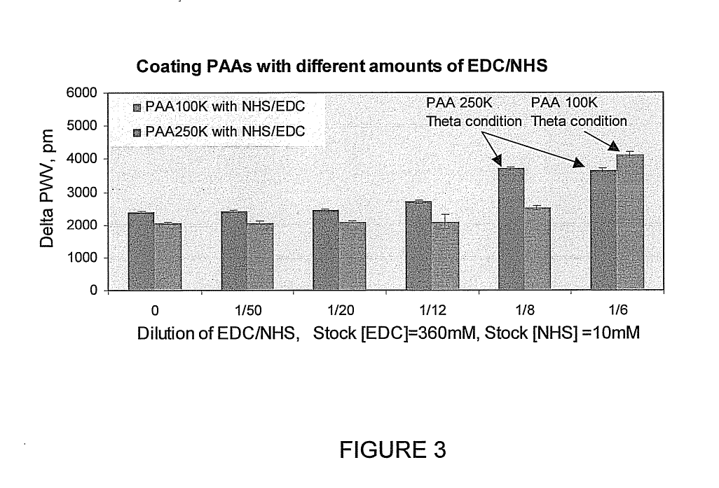

The results, as shown by PWV shift of the SWS biosensor, of the surface coating PAAs with different amounts of EDC/NHS are shown in FIG. 3. When the PAA solutions were mixed with low concentrations of EDC/NHS, the mixtures were clear solutions and the PWV shift was low. As EDC/NHS concentrations were increased to 1/8 dilution for PAA 250 KDa, or 1/6 for PAA 100K, the mixed solution started to become cloudy and the PWV shift increased sharply. The cloudy solution became clear after incubation for a short time. Thus, it appears that the larger size PAA 250 KDa reached the theta condition at lower EDC/NHS concentrations (1/8 dilution) as compared to the 1/6 dilution required to reach the theta condition of PAA 100 KDa. One explanation is that NHS reacts with the PAA side chains to produce a PAA-NHS ester product. When the number of NHS esters increases, PAA-NHS ester solubility declines and the solution becomes cloudy. The polymer chain may be shrinking into separated coils or clusters. This in turn should allow more PAA molecules to react with the crowded amine polymer hydrogel on the surface. As the NHS ester intermediate is not stable, it will degrade slowly in aqueous solution. Therefore, after attachment, PAA-NHS ester becomes PAA and NHS ester degrades. This reversible PAA-PAA NHS ester-PAA process enhances the PAA attachment to the surface.

In addition, the fact that the “theta condition” can be easily observed by unaided eye means that it can be used as a quality control (QC) validation of critical PAA/EDC/NHS solution status in a manufacturing process.

### Example 3

### Creating a Low COOH Density Surface

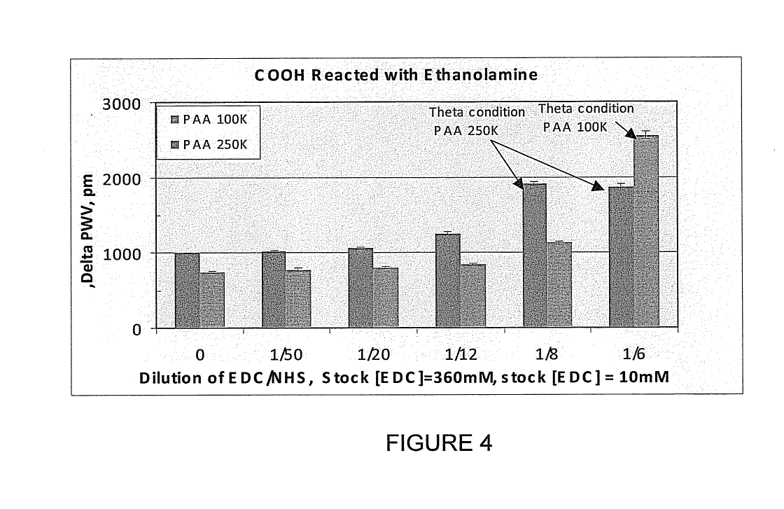

In order to control the COOH density of the high-density polymer surfaces created in Example 2, a mixture of 15 μL of 1M ethanolamine with 15 μL of 0.034M/1 mM EDC/NHS was added to the wells for 75 min to convert a specific number of COOH groups into OH groups, followed by a DI wash. Ethanolamine was added after the surfaces were stored for several hours, and therefore the PAA-NHS ester should have returned to PAA. The results of the test are shown in FIG. 4, expressed as delta PWV or PWV shift. As can be seen, the PAA that was attached to the surface using the “theta condition” reacted with more ethanolamine attested by the relative increase in the PWV shift.

### Example 4

### Protein Immobilization and Biotin Binding on High-Density Polymer Surfaces

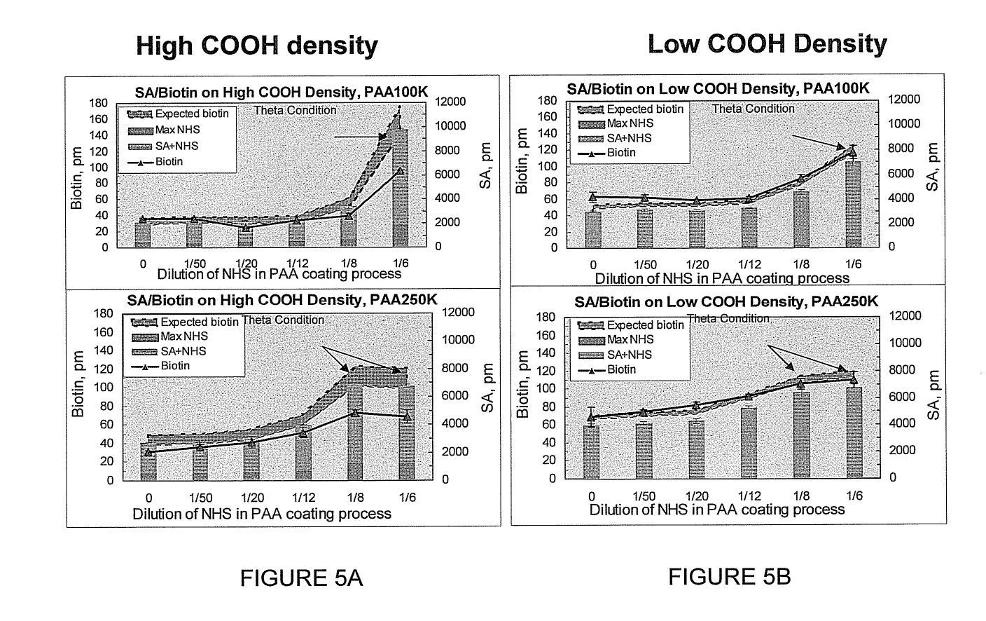

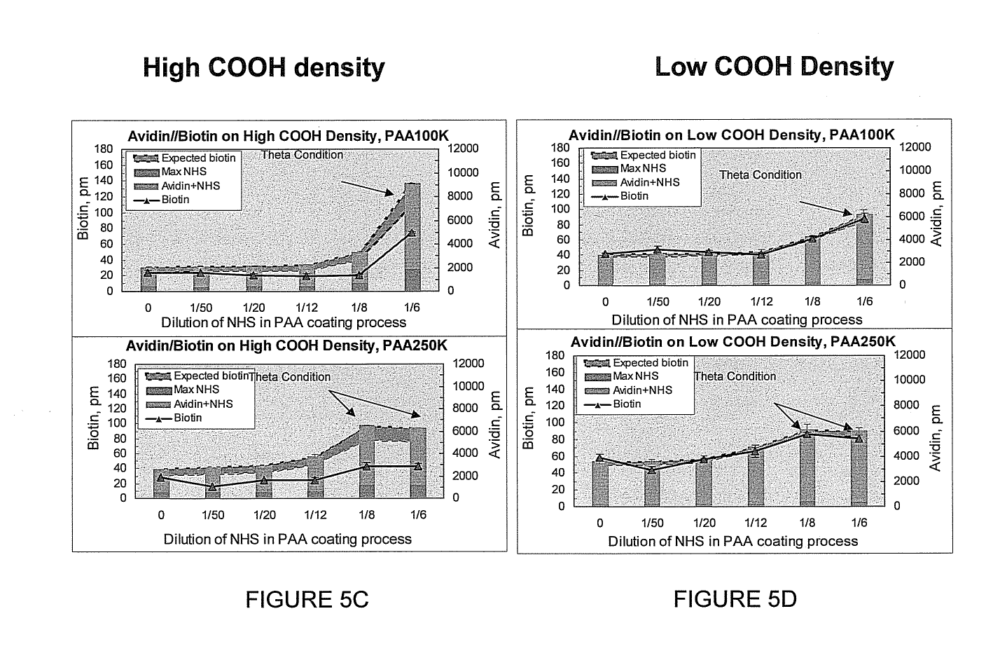

In order to immobilize protein to the novel surfaces, the high-density polymer surfaces of Examples 2 and 3 were activated by adding 0.34 M EDC/10 mM NHS in water for 10 min, followed by removing the solution. In an initial test of protein immobilization capability and protein activity following immobilization, biotin binding to immobilized streptavidin was used—20 μL of either 200 μg/ml avidin or streptavidin in a non-amine containing buffer (10 mM acetate buffer, pH 5.0) were added to the surface and incubated for 3 hr, followed by a wash first with the non-amine containing buffer, then PBS. Biotin was then added for binding to the immobilized avidin or streptavidin by using a 20 μL of a biotin solution in PBS to result in a final Biotin concentration of approximately 58 μM (N=4). The results of the different protein immobilizations and Biotin bindings are shown in FIG. 5. As can be seen, the PAA that was coated under “theta condition” resulted in not only more protein immobilization and also resulted in higher biotin binding—thus indicating higher activity.

The initial test was followed up by reacting different concentrations of avidin or streptavidin with the different high-density polymer surfaces. The various surfaces that were used for throughout these test are shown in the following table:

| PAA | EDC/NHS | COOH | PAA | EDC/NHS | COOH |
|---|---|---|---|---|---|
| polymer | dilution | density | polymer | dilution | density |
| PAA100K | 1/6 | high | PAA250K | 1/6 | high |
| PAA100K | 1/6 | low | PAA250K | 1/6 | low |
| PAA100K | 1/8 | high | PAA250K | 1/8 | high |
| PAA100K | 1/8 | low | PAA250K | 1/8 | low |
| PAA100K | 1/12 | high | PAA250K | 1/12 | high |
| PAA100K | 1/12 | low | PAA250K | 1/12 | low |
| PAA100K | 1/20 | high | PAA250K | 1/20 | high |
| PAA100K | 1/20 | low | PAA250K | 1/20 | low |
| PAA100K | 1/50 | high | PAA250K | 1/50 | high |
| PAA100K | 1/50 | low | PAA250K | 1/50 | low |
| PAA100K | 0 | high | PAA250K | 0 | high |
| PAA100K | 0 | low | PAA250K | 0 | low |

20 μL of either 0, 50, or 200 μg/ml avidin or streptavidin in a non-amine containing buffer were added to the wells after they were pre-activated for 10 min with EDC/NHS, and incubated for 3 hr. This was then followed by a wash first with the non-amine containing buffer. Biotin was then added for binding to the immobilized avidin or streptavidin by adding 20 μL of a biotin solution in PBS to result in a final Biotin concentration of approximately 58 μM (N=4).

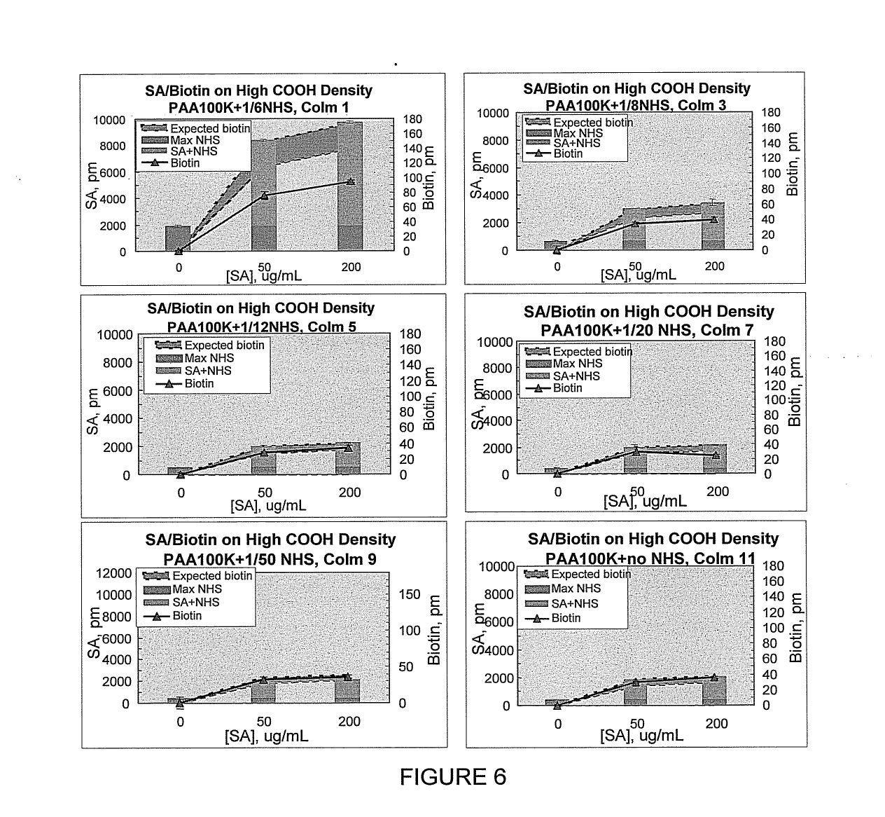

The results of immobilizing streptavidin on a high COOH density surface with PAA 100K, as expressed in PWV, can be seen in FIG. 6. More streptavidin was immobilized on PAA 100K high density surfaces coated with 1/6 dilution NHS/EDC (“theta condition”) as compared to the other EDC/NHS dilutions.

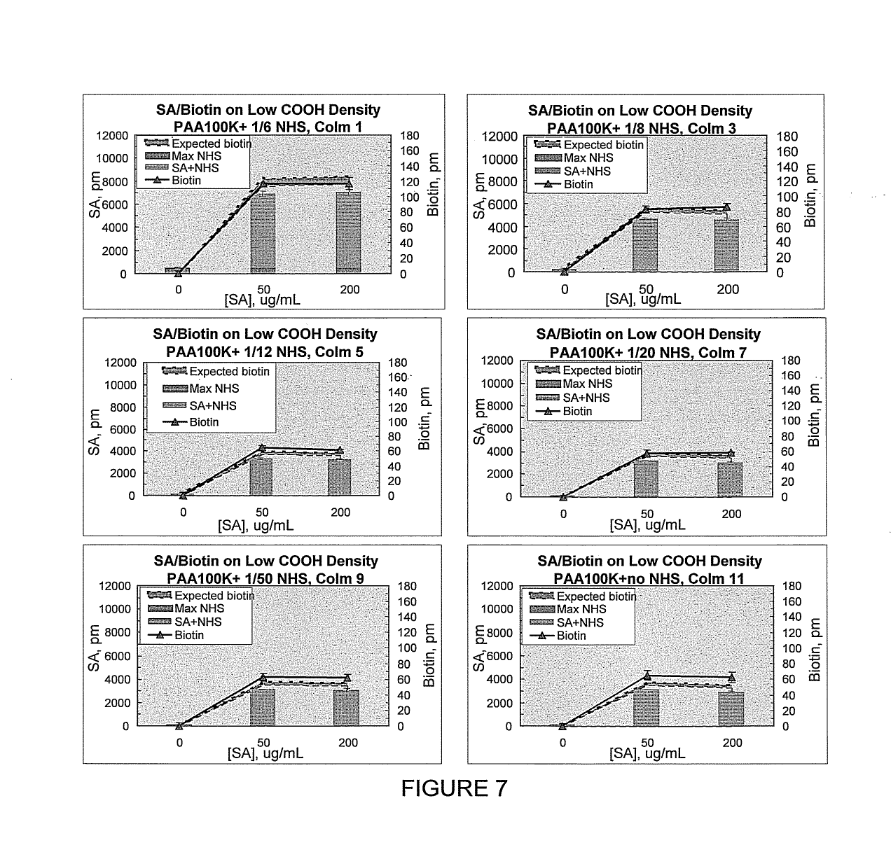

The results of immobilizing streptavidin on a low COOH density surface with PAA 100K, as expressed in PWV, can be seen in FIG. 7. More streptavidin was immobilized on PAA 100K low density surfaces coated with 1/6 dilution NHS/EDC (“theta condition”) as compared to the other EDC/NHS dilutions.

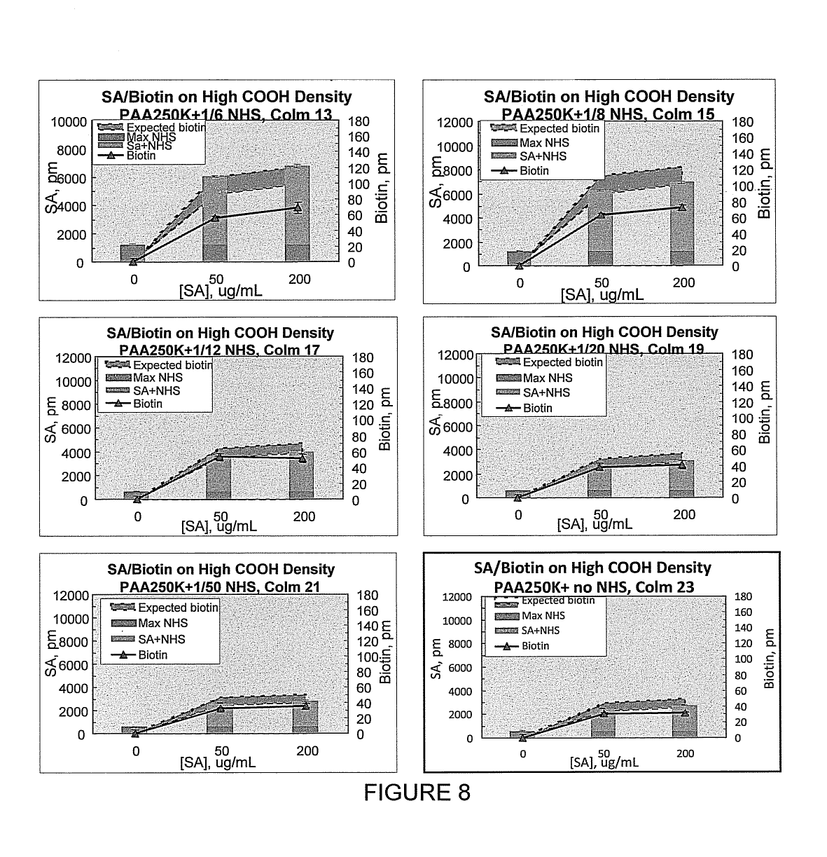

The results of immobilizing streptavidin on a high COOH density surface with PAA 250K, as expressed in PWV, can be seen in FIG. 8. More streptavidin was immobilized on PAA 250K high density surfaces coated with 1/6 and 1/8 dilution NHS/EDC (“theta condition”) as compared to the other EDC/NHS dilutions.

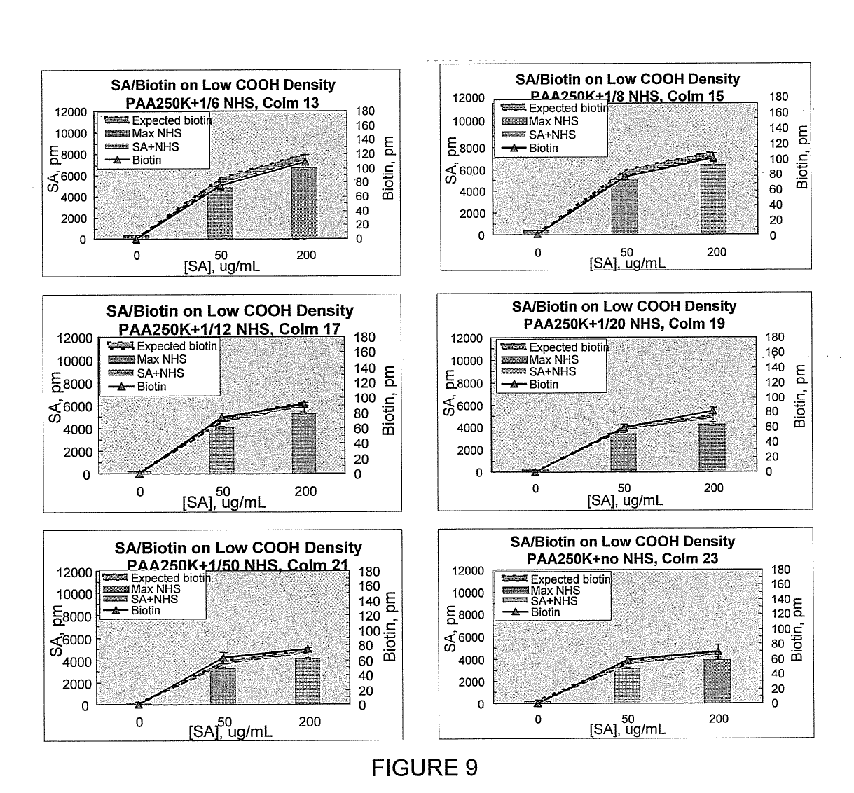

The results of immobilizing streptavidin on a low COOH density surface with PAA 250K, as expressed in PWV, can be seen in FIG. 9. More streptavidin was immobilized on PAA 250K high density surfaces coated with 1/6 and 1/8 dilution NHS/EDC (“theta condition”) as compared to the other EDC/NHS dilutions.

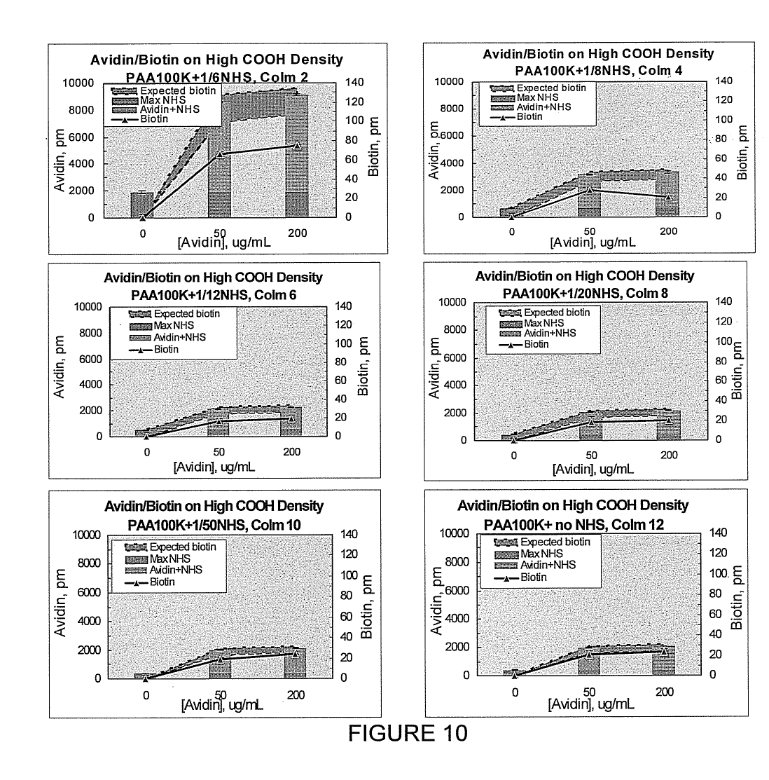

The results of immobilizing avidin on a high COOH density surface with PAA 100K, as expressed in PWV, can be seen in FIG. 10. More avidin was immobilized on PAA 100K high density surfaces coated with 1/6 dilution NHS/EDC (“theta condition”) as compared to the other EDC/NHS dilutions.

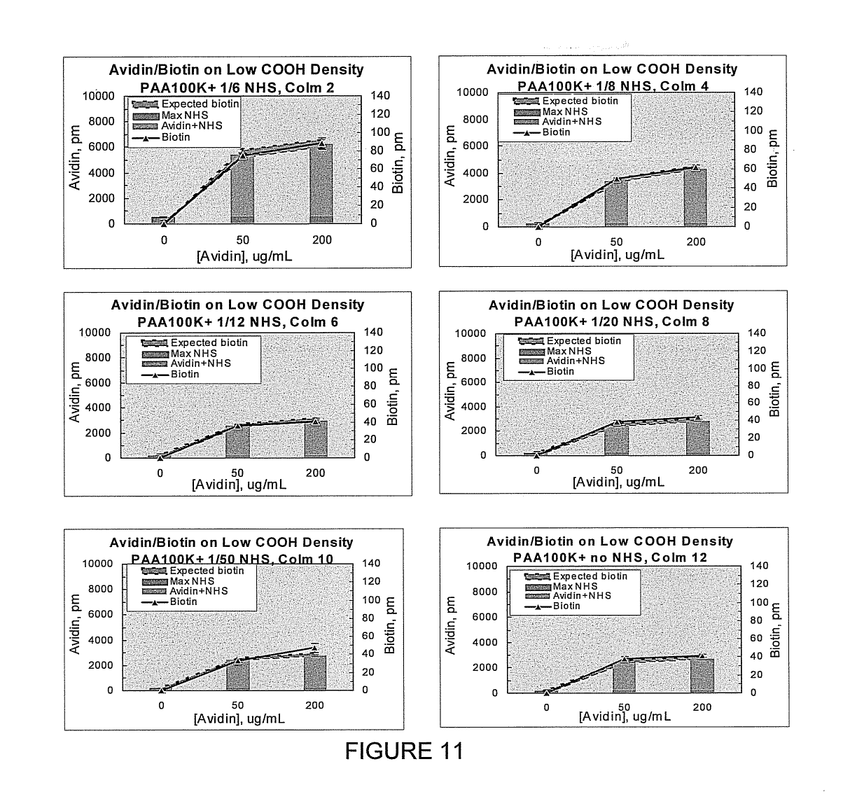

The results of immobilizing avidin on a low COOH density surface with PAA 100K, as expressed in PWV, can be seen in FIG. 11. More avidin was immobilized on PAA 100K low density surfaces coated with 1/6 dilution NHS/EDC (“theta condition”) as compared to the other EDC/NHS dilutions.

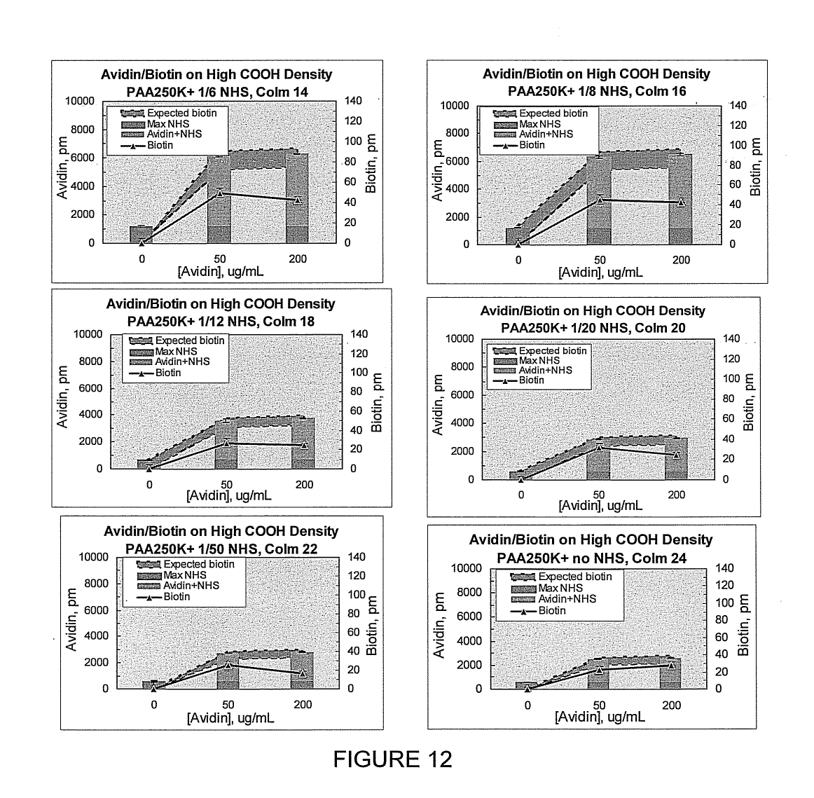

The results of immobilizing avidin on a high density COOH surface with PAA 250,000 Da, as expressed in PWV, can be seen in FIG. 12. More avidin was immobilized on PAA 250K high density surfaces coated with 1/6 and 1/8 dilution NHS/EDC (“theta condition”) as compared to the other EDC/NHS dilutions.

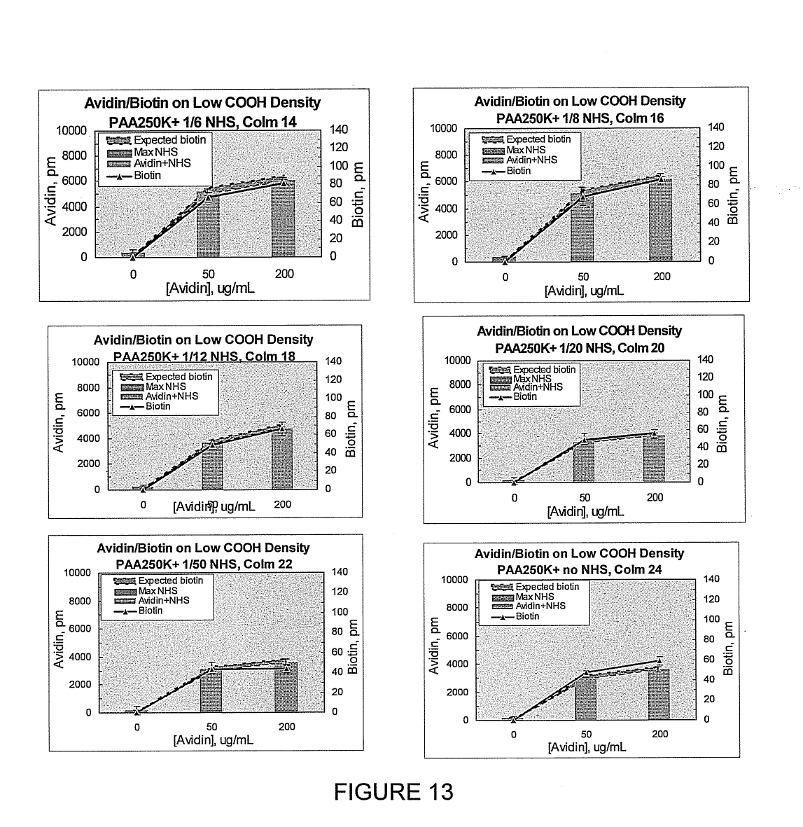

The results of immobilizing avidin on a low COOH density surface with PAA 250K, as expressed in PWV, can be seen in FIG. 13. More avidin was immobilized on PAA 250K high density surfaces coated with 1/6 and 1/8 dilution NHS/EDC (“theta condition”) as compared to the other EDC/NHS dilutions.

These results demonstrate under “theta condition,” PAA coated on the surface improved the immobilization of streptavidin (pI 5.0) and avidin (pI 10.5). The delta PWVs were well above 8 m, at 50 μg/ml and 9 nm at 200 μg/ml for both proteins. In addition, the results of the biotin binding show that low COOH density surfaces maintain more activity of streptavidin and avidin for biotin interaction. Further, PAA 100K showed better performance than PAA 250K for both streptavidin and avidin.

### Example 5

### Trypsin Immobilization on High-Density Polymer Surfaces

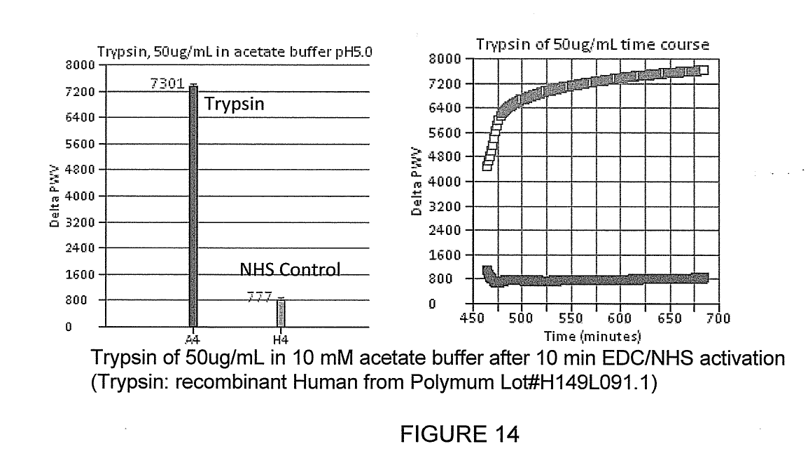

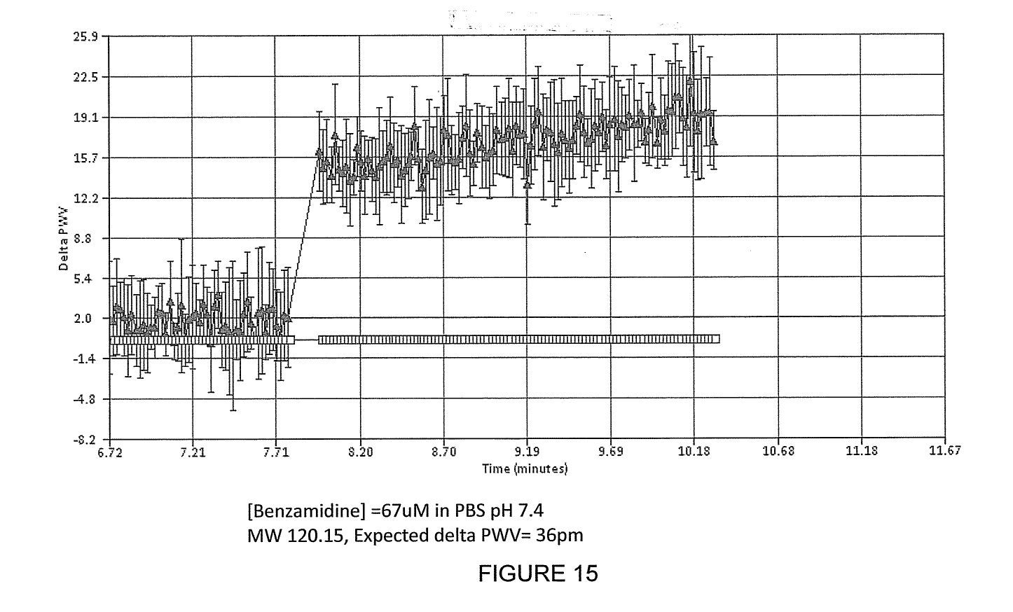

Trypsin was tested to determine what other proteins could be successfully immobilized on high-density polymer surfaces. Like above, high-density polymer surfaces were activated by adding 0.34 M EDC/10 mM NHS in water for 10 min, followed by removing the solution. 50 μg/ml trypsin in non-amine containing buffer was added to the wells, and was incubated for up to around 700 min, followed by a wash first with acetic buffer, then PBS. The trypsin was recombinant human protein from Polymum Lot#H149L091.1. The results of trypsin binding over time, as a function of delta PWV, are shown in FIG. 14, as well as an NHS control. 90% of the protein was immobilized within less than 2 hr. Benzamidine was then added for binding to the immobilized trypsin by adding benzamidine at a final concentration of 67 μM in PBS, pH 7.4. Benzamidine has a molecular weight of 120.15, and an expected delta PWV or PWV shift of 36 pm. The results of the benzamidine experiment are shown in FIG. 15.

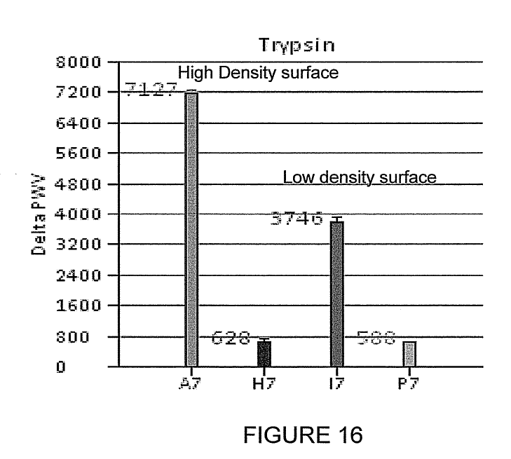

Trypsin binding was also measured on both high and low COOH density surfaces. 100 μg of human recombinant trypsin in 10 mM acetate buffer pH 5.0 was immobilized on either a high or low COOH density surface for 3 hr. The results of this immobilization are shown in FIG. 16. As can be seen, tryspin immobilized rapidly on the high density surface, while immobilization was slow but rising constantly (even after 3 hr) on the low density surface.

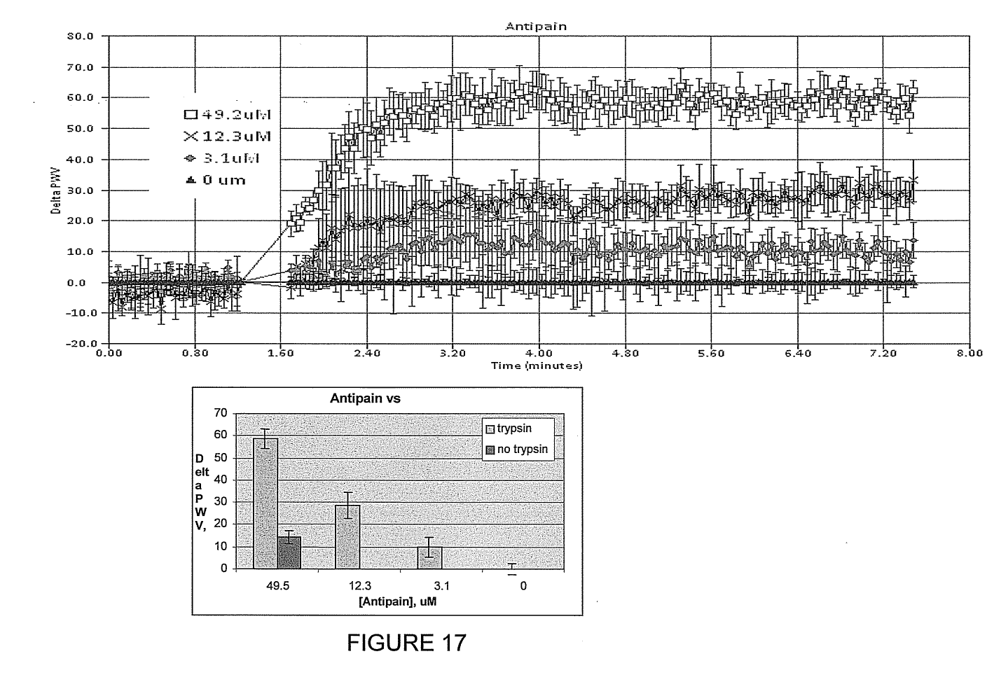

Antipain was then added for binding to the low COOH density surfaces. 49.2, 12.3, 3.1, and 1 μM antipain dihydrochloride in PBS was prepared from a microbial source and was added to the 3.8 nm delta PWV shift from trypsin immobilization. 49.2 μM antipain was also added to no trypsin control wells (N=4). The results of this binding over time are shown in FIG. 17. Titration of antipain was observed on 3.8 nm delta PWV trypsin immobilized on low density surface. No positive result was observed on 7.2 nm delta PWV trypsin immobilization to a high density surface. The theoretical shift of antipain of 1:1 binding on 3.8 nm delta PWV shift trypsin surface is 95 nm. The control, 49.2 μM antipain in a well with no trypsin immobilization, had 14 nm bulk or NSB PWV shift.

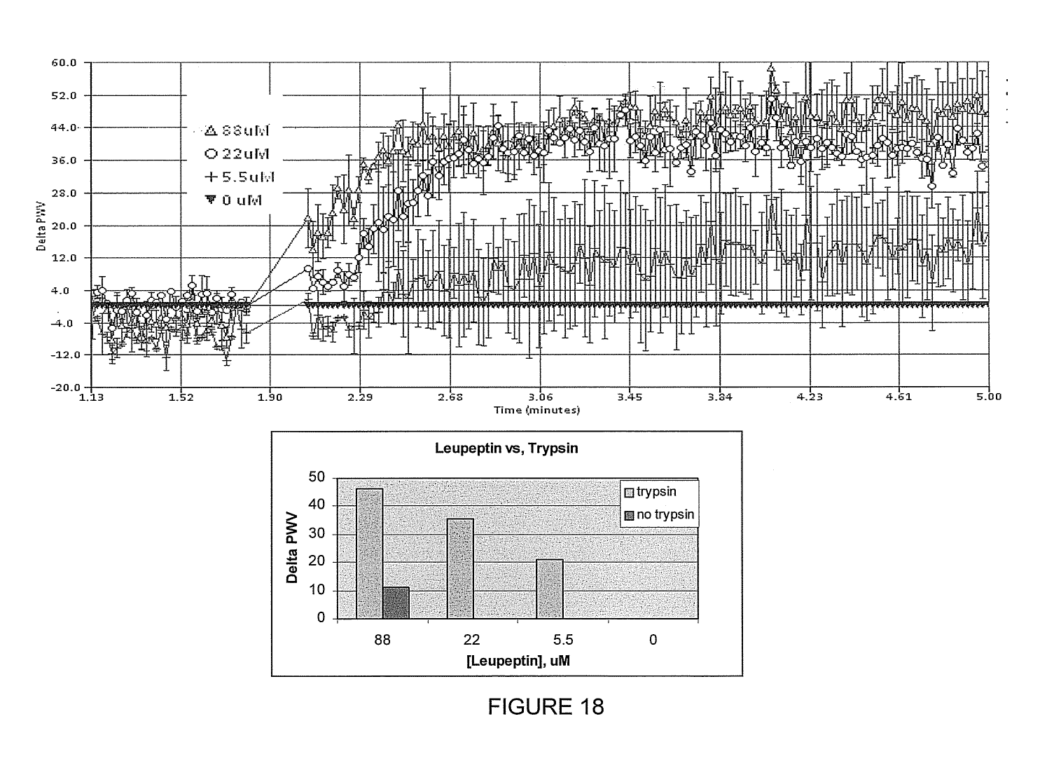

Leupeptin was also added for binding to the low COOH density surfaces. 88, 22, 5.5, and 0 μM leupeptin dihydrochloride solutions in PBS were prepared and were added to the 3.8 nm delta PWV shift trypsin immobilization surfaces. 88 μM leupeptin was also added to no trypsin control wells (N=2). The results of this binding over time are shown in FIG. 18. Titration of leupeptin was observed on 3.8 nm delta PWV shift trypsin immobilized on the low density surface. No positive result was observed on 7.2 nm delta PWV trypsin immobilized on the high density surface. The theoretical shift of leupeptin of 1:1 binding on 3.8 nm delta PWV trypsin is 66 nm. The control 88 μM leupeptin with no trypsin immobilization had 12 nm bulk or NSB shift.

The invention and the manner and process of making and using it, are now described in such full, clear, concise and exact terms as to enable any person skilled in the art to which it pertains, to make and use the same. It is to be understood that the foregoing describes preferred embodiments of the invention and that modifications may be made therein without departing from the spirit or scope of the invention as set forth in the claims.

What is claimed is:

1. A high-density polymer surface, comprising carboxyl-containing polymers attached to a surface.

2. The high-density polymer surface of claim 1, wherein the carboxyl-containing polymers are attached to one or more amine groups on the surface.

3. The high-density polymer surface of claim 2, wherein the carboxyl-containing polymers are reacted with one or more carboxylic-acid activating reagents prior to attachment to one or more amine groups on the surface.

4. The high-density polymer surface of claim 3, wherein the one or more carboxylic-acid activating reagents comprise N-hydroxysulfo-succinimide.

5. The high-density polymer surface of claim 2, wherein the one or more amine groups on the surface are from one or more amine-containing polymers attached to the surface.

6. The high-density polymer surface of claim 5, wherein the one or more amine-containing polymers are attached to an epoxy-coated surface.

7. The high-density polymer surface of claim 6, wherein the one or more amine-containing polymers comprise polyvinylamine.

8. The high-density polymer surface of claim 3, wherein the carboxyl-containing polymers comprise polyacrylic acid.

9. The high-density polymer surface of claim 5, wherein the carboxyl-containing polymers comprise polyacrylic acid.

10. The high-density polymer surface of claim 6, wherein the carboxyl-containing polymers comprise polyacrylic acid.

11. The high-density polymer surface of claim 8, wherein the polyacrylic acid polymers are covalently attached to one or more ethanolamine molecules.

12. The high-density polymer surface of claim 9, wherein the polyacrylic acid polymers are covalently attached to one or more ethanolamine molecules.

13. The high-density polymer surface of claim 10, wherein the polyacrylic acid polymers are covalently attached to one or more ethanolamine molecules.

14. A method of creating a high-density polymer surface, comprising attaching carboxyl-containing polymers to an amine-functionalized surface in the presence of carboxylic-acid activating reagents under conditions where one or more carboxyl-containing polymers react with the amine-functionalized surface.

15. The method of claim 14, wherein the carboxyl-containing polymers are reacted with the carboxylic-acid activating reagents prior to the addition to the amine-functionalized surface.

16. The method of claim 15, wherein the carboxyl-containing polymers comprise polyacrylic acid.

17. The method of claim 16, wherein the carboxylic-acid activating reagents comprise N-hydroxysulfo-succinimide.

18. The method of claim 14, wherein the one or more amine groups on the surface are prepared by treating the surface with epoxy silane and by attaching one or more amine-containing polymers to the epoxy-functionalized surface.

19. The method of claim 18, wherein the one or more amine-containing polymers comprise polyvinylamine.

20. The method of claim 15, further comprising the step of attaching one or more ethanolamine molecules to the one or more carboxyl-containing polymers attached to the surface.

21. The method of claim 16, further comprising the step of attaching one or more ethanolamine molecules to the one or more polyacrylic polymers attached to the surface.

22. The method of claim 14, further comprising the step of attaching one or more chemical or biological molecules to the one or more carboxyl-containing attached to the surface.

23. The method of claim 22, wherein the chemical or biological molecules comprise proteins.

24. The method of claim 22, wherein the chemical or biological molecules are proteins.

25. The method of claim 22, wherein the chemical or biological molecules comprise proteins that have a high primary amine density.

26. The method of claim 22, wherein the chemical or biological molecules are proteins that have a high primary amine density.

27. The method of claim 22, wherein the chemical or biological molecules comprise proteins that have a pI greater than about 7.

28. The method of claim 22, wherein the chemical or biological molecules are proteins that have a pI greater than about 7.

29. The method of claim 22, wherein the chemical or biological molecules comprise proteins that have a pI greater than about 9.

30. The method of claim 22, wherein the chemical or biological molecules are proteins that have a pI greater than about 9.

31. The method of claim 16, further comprising the step of attaching one or more chemical or biological molecules to the one or more polyacrylic acid polymers attached to the surface.

32. The method of claim 31, wherein the chemical or biological molecules comprise proteins.

33. The method of claim 31, wherein the chemical or biological molecules are proteins.

34. The method of claim 31, wherein the chemical or biological molecules comprise proteins that have a high primary amine density.

35. The method of claim 31, wherein the chemical or biological molecules are proteins that have a high primary amine density.

36. The method of claim 31, wherein the chemical or biological molecules comprise proteins that have a pI greater than about 7.

37. The method of claim 31, wherein the chemical or biological molecules are proteins that have a pI greater than about 7.

38. The method of claim 31, wherein the chemical or biological molecules comprise proteins that have a pI greater than about 9.

39. The method of claim 31, wherein the chemical or biological molecules are proteins that have a pI greater than about 9.

40. A method of immobilizing chemical or biological molecules on a surface, comprising contacting chemical or biological molecules with the high-density polymer surface of claim 2.

41. The method of claim 40, wherein the chemical or biological molecules comprise proteins.

42. The method of claim 40, wherein the chemical or biological molecules are proteins.

43. The method of claim 40, wherein the chemical or biological molecules comprise high primary amine density proteins.

44. The method of claim 40, wherein the chemical or biological molecules are high primary amine density proteins.

45. A method of immobilizing chemical or biological molecules on a surface, comprising contacting chemical or biological molecules with the high-density polymer surface of claim 5.

46. The method of claim 45, wherein the chemical or biological molecules comprise proteins.

47. The method of claim 45, wherein the chemical or biological molecules are proteins.

48. The method of claim 45, wherein the chemical or biological molecules comprise high primary amine density proteins.

49. The method of claim 45, wherein the chemical or biological molecules are high primary amine density proteins.

50. A high-density polymer surface, comprising aldehyde-containing polymers attached to a surface.

51. The high-density polymer surface of claim 50, wherein the aldehyde-containing polymers are attached to one or more amine groups on the surface.

52. The high-density polymer surface of claim 51, wherein the aldehyde-containing polymers are reacted with one or more aldehyde-activating reagents prior to attachment to the one or more amine groups on the surface.

53. The high-density polymer surface of claim 52, wherein the one or more aldehyde-activating reagents comprise amine groups.

54. The high-density polymer surface of claim 51, wherein the one or more amine groups on the surface are from one or more amine-containing polymers attached to the surface.

55. The high-density polymer surface of claim 54, wherein the one or more amine-containing polymers are attached to an epoxy-coated surface.

56. The high-density polymer surface of claim 55, wherein the one or more amine-containing polymers comprise polyvinylamine.

57. A method of creating a high-density polymer surface, comprising attaching aldehyde-containing polymers to an amine-functionalized surface in the presence of aldehyde-activating reagents under conditions where one or more aldehyde-containing polymers react with the amine-functionalized surface.
